(19) United States
(12) Patent Application Publication
(10) Pub. No.: US 2025/0323838 A1
(43) Pub. Date: Oct. 16, 2025

(54) METHODS AND APPARATUS FOR COMMUNICATION OF UPDATES FOR A MACHINE-LEARNING MODEL

(71) Applicant: Huawei Technologies Co., Ltd., Shenzhen (CN)

(72) Inventors: Liqing Zhang, Ottawa (CA); Hao Tang, Ottawa (CA); Lei Dong, Shanghai (CN); Jianglei Ma, Ottawa (CA)

(21) Appl. No.: 19/090,070

(22) Filed: Mar. 25, 2025

Related U.S. Application Data
(63) Continuation of application No. PCT/CN2022/122962, filed on Sep. 30, 2022.

(51) Int. Cl. H04L 41/16; H04W 72/115

(52) U.S. Cl. CPC H04L 41/16; H04W 72/115

(57) ABSTRACT

According to the present disclosure, it may be determined whether or not an update to a parameter of a machine-learning model is to be transmitted based on an evaluation of the training of the machine-learning model. The transmission of updates to a machine-learning model may be based on an evaluation of the training of the machine-learning model.

### CROSS-REFERENCE TO RELATED APPLICATION

This application is a continuation of International Application No. PCT/CN2022/122962, titled “METHODS AND APPARATUS FOR COMMUNICATION OF UPDATES FOR MACHINE-LEARNING MODEL,” filed on Sep. 30, 2022, all the contents of which are hereby incorporated by reference.

### TECHNICAL FIELD

The application relates to machine-learning and, in particular, to the communication of updates to values of parameters of a machine-learning model.

### BACKGROUND

In federated learning, training of a machine-learning model, or part of the machine-learning model, may be distributed across multiple nodes, referred to as local nodes. This allows for taking advantage of the different training datasets and different computing capabilities of different local nodes. For example, a network may broadcast a common machine-learning model to multiple local nodes. The broadcasted machine-learning model may include parameters of the machine-learning model, such as weights. Each local node may train the machine-learning model using local training data over one or more iterations and determines parameter gradients for the machine-learning model. The parameter gradients may also be referred to as the slopes of the model parameters. Each local node may report the gradients to the network. The network may receive reports from multiple local nodes and update a common machine-learning model based on the reports. This training cycle may be repeated (e.g. over one or more rounds) until the common machine-learning model converges or the network determines to stop training the machine-learning model (e.g. based on certain criteria). Federated learning, which may also be referred to as distributed learning, can be particularly advantageous in situations in which the training data for this model is private such that access to the training should be restricted. By training the model at local nodes, the training data can be used to train the model without sharing the training data with the wider network. This provides privacy protection for local nodes, which is a principle of 6^{th} Generation (6G) networks.

### SUMMARY

Federated learning can incur significant signaling overhead. For federated learning in a deep neural network (DNN), for example, the DNN may include a large number of parameters. Small models can include as many as 6 million parameters, constituting around 1 MB, large models can include as many as 200 million parameters constituting around 10 MB, and very large models may include a billion parameters, constituting several gigabytes of data. Each local node may report updates to each of the model parameters in each training round, so the equivalent number of gradients is transmitted to the network in each training round (e.g. each local node transmits one gradient per parameter in the machine-learning model in each training round). In cellular networks, this information is typically transmitted over an air link (e.g. a wireless link), occupying time and frequency resources as well as computing and power resources. As a result, solutions for reducing the signaling overhead in federated learning are needed.

According to the present disclosure, it may be determined whether or not an update to a parameter of a machine-learning model is to be transmitted based on an evaluation of the training of the machine-learning model. It will be appreciated that training performance at a particular training node may vary during training. By basing the transmission of updates for a machine-learning model on an evaluation of the training of the machine-learning model, updates that are unlikely to significantly improve the accuracy of the global (e.g. aggregated) machine-learning model or updates that may even reduce the accuracy of the global machine-learning model might not be transmitted, which reduces the signaling overhead involved in federated learning processes. Updates that are likely to significantly improve the accuracy of the global machine-learning model may be transmitted, allowing the global model to be updated efficiently whilst minimising signaling overhead. Aspects of the present disclosure thus provide means for reducing the signaling overhead of training a machine-learning process using one or more training nodes.

In an aspect, a method performed by a training node is provided. The method may involve receiving configuration signaling indicating a metric associated with training of a machine-learning model. Training of the machine-learning model may be performed to obtain an updated machine-learning model with updates to values of parameters of the machine-learning model. The metric may be used for evaluation of the training associated with the updates. The method may also involve transmitting an indication of whether at least one of the updates is to be transmitted to a coordinator node. The indication may be based on the evaluation of the training associated with the updates.

Receiving the configuration signaling indicating the metric may involve receiving an indication at least one of: an evaluation parameter for evaluation of the training, a rule for deciding whether or not an update is to be transmitted, and a threshold for determining which of the updates are to be transmitted.

The indication may signal a transmission mode. The transmission mode may indicate at least one of the updates is to be transmitted. The transmission mode may indicate none of the updates are to be transmitted. The transmission mode may indicate at least one of the updates is to be transmitted. The method may also involve transmitting the at least one of the updates to the coordinator node in accordance with the transmission mode.

The method may also involve receiving a grant scheduling one or more resources to be used for transmission, to the coordinator node, of the at least one of the updates. The grant may be received from the coordinator node. Transmitting the at least one of the updates to the coordinator node in accordance with the transmission mode may involve transmitting the at least one of the updates using the one or more resources.

Transmitting the at least one of the updates to the coordinator node may involve transmitting a subset of the updates to the coordinator node. The method may also involve transmitting a parameter indicator to the coordinator node. The parameter indicator may identify the subset of the updates that are to be transmitted to the coordinator node. Transmitting the parameter indicator to the coordinator node may involve transmitting the parameter indicator and the subset of the updates to the coordinator node in a same message.

The parameter indicator may indicate one or more of: one or more layers of the machine-learning model, one or more parameters for a layer of the machine-learning model, a number of the subset of the updates that are to be transmitted, and an identifier of the machine-learning model.

The metric may be based on a fitting status of the updated model. The fitting status may comprise one of: underfitting of the updated model, overfitting of the updated model or neither underfitting nor overfitting of the updated model. The metric may be based on a characteristic of the updates to the values of the parameters of the machine-learning model. The characteristic of the updates may include one or more of the following: an absolute size of the updates, a size of a respective update to the respective value of the parameter relative to the respective value of the parameter, and for each of the updates to the values of the parameters, a size of the respective update to the respective value of the respective parameter relative to an earlier update to an earlier value of the parameter.

In a further aspect, a training node (e.g. an entity or apparatus) configured to perform the above-mentioned method is also provided. The training node may include a processor and a memory (e.g. a non-transitory processor-readable medium). The memory stores instructions (e.g. processor-readable instructions) which, when executed by a processor of a training node, cause the training node to perform the method above. In another aspect, the memory may be provided (e.g. separate to the training node).

In another aspect, a method performed by a training node is provided. The method may involve transmitting an indication of evaluation of training of a machine-learning model. The indication of the evaluation of the training may be transmitted to a coordinator node. Training of the machine-learning model may be performed to obtain an updated machine-learning model with updates to values of parameters of the machine-learning model. A metric may be used for evaluation of the training associated with the updates. The method may also involve receiving, from the coordinator node, an indication of whether to transmit at least one of the updates to the coordinator node.

The metric may be based on a fitting status of the updated model. The fitting status may comprise one of: underfitting of the updated model, overfitting of the updated model or neither underfitting nor overfitting of the updated model. The metric may be based on a characteristic of the updates to the values of the parameters of the machine-learning model. The characteristic of the updates may include one or more of the following: an absolute size of the updates, a size of a respective update to the respective value of the parameter relative to the respective value of the parameter, and for each of the updates to the values of the parameters, a size of the respective update to the respective value of the respective parameter relative to an earlier update to an earlier value of the parameter.

In a further aspect, a training node (e.g. an entity or apparatus) configured to perform the above-mentioned method is also provided. The training node may include a processor and a memory (e.g. a non-transitory processor-readable medium). The memory stores instructions (e.g. processor-readable instructions) which, when executed by a processor of a training node, cause the training node to perform the method above. In another aspect, the memory may be provided (e.g. separate to the training node).

In another aspect, a method performed by a coordinator node is provided. The method may involve receiving an indication of evaluation of training of a machine-learning model to obtain an updated machine-learning model with updates to values of parameters of the machine-learning model. The indication may be received from a training node. A metric may be used for evaluation of the training associated with the updates. The method may also involve, based on the indicated evaluation, indicating, to the training node, whether to transmit at least one of the updates to the coordinator node.

Indicating, to the training node, whether to transmit at least one of the updates to the coordinator node may involve signaling a transmission mode to the training node. The transmission mode may be based on the indicated metric. The transmission mode may indicate whether to transmit none, some or all of the updates to the coordinator node.

Indicating, to the training node, whether to transmit at least one of the updates to the coordinator node may involve transmitting a parameter indicator to the training node. The parameter indicator may identify a subset of the updates to be transmitted to the coordinator node.

The method may also involve transmitting, to the training node, a grant scheduling one or more resources to be used for transmission, to the coordinator node, of the subset of the updates. The method may also involve receiving, from the training node, the subset of the updates transmitted on the one or more resources.

The metric may be based on a fitting status of the updated model. The metric may be based on a characteristic of the updates to the values of the parameters of the machine-learning model.

In a further aspect, a coordinator node (e.g. an entity or apparatus) configured to perform the above-mentioned method is also provided. The coordinator node may include a processor and a memory (e.g. a non-transitory processor-readable medium). The memory stores instructions (e.g. processor-readable instructions) which, when executed by a processor of a coordinator node, cause the coordinator node to perform the method above. In another aspect, the memory may be provided (e.g. separate to the coordinator node).

In another aspect, a training node is provided. The training node may include a processor and a memory. The memory stores instructions which, when executed by the processor, may cause the training node to receive configuration signaling indicating a metric associated with training of a machine-learning model. Training of the machine-learning model may be performed to obtain an updated machine-learning model with updates to values of parameters of the machine-learning model. The metric may be used for evaluation of the training associated with the updates. The instructions, when executed by the processor, may further cause the training node to transmit an indication of whether at least one of the updates is to be transmitted to a coordinator node. The indication may be based on the evaluation of the training associated with the updates.

The instructions, when executed by the processor, may further cause the training node to receive the configuration signaling indicating the metric by receiving an indication at least one of: an evaluation parameter for evaluation of the training, a rule for deciding whether or not an update is to be transmitted, and a threshold determining which of the updates.

The indication may signal a transmission mode. the transmission mode may indicate at least one of the updates is to be transmitted. The transmission mode may indicate none of the updates are to be transmitted.

The transmission mode may indicate at least one of the updates is to be transmitted. When the instructions are executed by the processor, the training node may be caused to transmit the at least one of the updates to the coordinator node in accordance with the transmission mode.

When the instructions are executed by the processor, the training node may be caused to receive, from the coordinator node, a grant scheduling one or more resources to be used for transmission, to the coordinator node, of the at least one of the updates. Transmitting the at least one of the updates to the coordinator node in accordance with the transmission mode may involve transmitting the at least one of the updates using the one or more resources.

When the instructions are executed by the processor, the training node may be caused to transmit the at least one of the updates to the coordinator node by transmitting a subset of the updates to the coordinator node.

When the instructions are executed by the processor, the training node may be further caused to transmit a parameter indicator to the coordinator node. The parameter indicator may identify the subset of the updates that are to be transmitted to the coordinator node. The training node may be caused to transmit the parameter indicator to the coordinator node by transmitting the parameter indicator and the subset of the updates to the coordinator node in a same message.

The parameter indicator may indicate one or more of: one or more layers of the machine-learning model, one or more parameters for a layer of the machine-learning model, a number of the subset of the updates that are to be transmitted, and an identifier of the machine-learning model.

The metric may be based on a fitting status of the updated model. The fitting status may comprise one of: underfitting of the updated model, overfitting of the updated model or neither underfitting nor overfitting of the updated model. The metric may be based on a characteristic of the updates to the values of the parameters of the machine-learning model. The characteristic of the updates may include one or more of the following: an absolute size of the updates, a size of a respective update to the respective value of the parameter relative to the respective value of the parameter, and for each of the updates to the values of the parameters, a size of the respective update to the respective value of the respective parameter relative to an earlier update to an earlier value of the parameter.

In another aspect, a training node is provided. The training node may include a processor and a memory. The memory stores instructions which, when executed by the processor, may cause the training node to transmit, to a coordinator node, an indication of evaluation of training of a machine-learning model. Training of the machine-learning model may be performed to obtain an updated machine-learning model with updates to values of parameters of the machine-learning model. A metric may be used for evaluation of the training associated with the updates. The training node may be further caused to receive, from the coordinator node, an indication of whether to transmit at least one of the updates to the coordinator node.

The metric may be based on a fitting status of the updated model. The fitting status may comprise one of: underfitting of the updated model, overfitting of the updated model or neither underfitting nor overfitting of the updated model. The metric may be based on a characteristic of the updates to the values of the parameters of the machine-learning model. The characteristic of the updates may include one or more of the following: an absolute size of the updates, a size of a respective update to the respective value of the parameter relative to the respective value of the parameter, and for each of the updates to the values of the parameters, a size of the respective update to the respective value of the respective parameter relative to an earlier update to an earlier value of the parameter.

In another aspect, a coordinator node is provided. The coordinator node may include a processor and a memory. The memory stores instructions which, when executed by the processor, may cause the coordinator node to receive, from a training node, an indication of evaluation of training of a machine-learning model to obtain an updated machine-learning model with updates to values of parameters of the machine-learning model. A metric may be used for evaluation of the training associated with the updates. The coordinator node may be further caused to, based on the indicated evaluation, indicate, to the training node, whether to transmit at least one of the updates to the coordinator node.

When the instructions are executed by the processor, the coordinator node may be caused to indicate, to the training node, whether to transmit at least one of the updates to the coordinator node by signaling a transmission mode to the training node, wherein the transmission mode is based on the indicated metric. The transmission mode may indicate whether to transmit none, some or all of the updates to the coordinator node.

When the instructions are executed by the processor, the coordinator node may be caused to indicate, to the training node, whether to transmit at least one of the updates to the coordinator node by transmitting a parameter indicator to the training node. The parameter indicator may identify a subset of the updates to be transmitted to the coordinator node.

When the instructions are executed by the processor, the coordinator node may be further caused to transmit, to the training node, a grant scheduling one or more resources to be used for transmission, to the coordinator node, of the subset of the updates. The coordinator node may be further caused to receive, from the training node, the subset of the updates transmitted on the one or more resources.

The metric may be based on a fitting status of the updated model. The metric may be based on a characteristic of the updates to the values of the parameters of the machine-learning model.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 is a schematic diagram of a communication system in which embodiments of the disclosure may occur.

FIG. 2 is another schematic diagram of a communication system in which embodiments of the disclosure may occur.

FIG. 3 is a block diagram illustrating units or modules in a device in which embodiments of the disclosure may occur.

FIG. 4 is a block diagram illustrating units or modules in a device in which embodiments of the disclosure may occur.

FIG. 5 shows a system comprising a coordinator node and a plurality of training nodes according to embodiments of the disclosure.

FIG. 6 illustrates the updates of a parameter of a machine-learning model in different rounds of training of the machine-learning model according to embodiments of the disclosure.

FIG. 7 shows a histogram of updates to parameters of a machine-learning model in a training round according to embodiments of the disclosure.

FIG. 8 indicates the fitting status for an updated model in different rounds of training of a machine-learning model according to embodiments of the disclosure.

FIG. 9 shows the structure of a machine-learning model according to embodiments of the disclosure.

FIG. 10 shows the format for an indication message according to embodiments of the disclosure.

FIGS. 11-19 show diagrams and flowcharts of methods according to embodiments of the disclosure.

### DETAILED DESCRIPTION

The operation of the current example embodiments and the structure thereof are discussed in detail below. It should be appreciated, however, that the present disclosure provides many applicable inventive concepts that can be embodied in any of a wide variety of specific contexts. The specific embodiments discussed are merely illustrative of specific structures of the disclosure and ways to operate the disclosure, and do not limit the scope of the present disclosure.

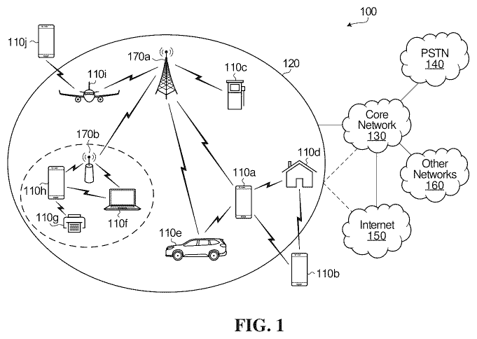

Referring to FIG. 1, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

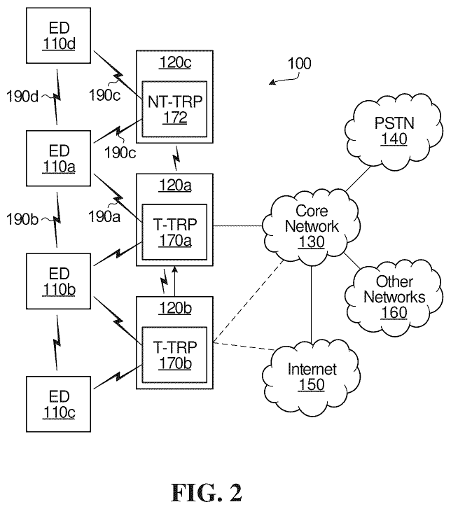

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

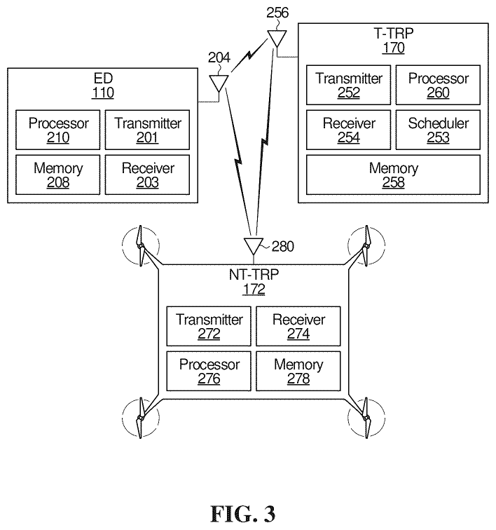

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forging devices or apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

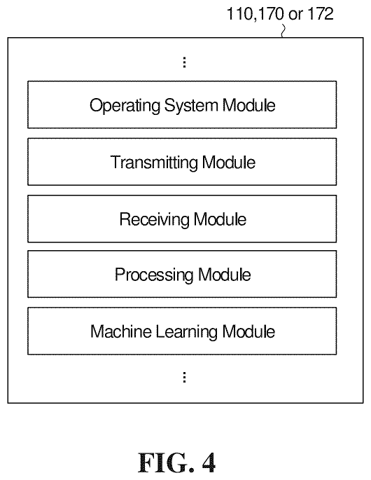

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine-learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

### Communication of Updates for a Machine-Learning Model

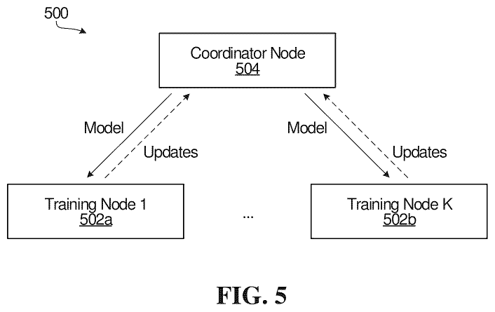

FIG. 5 shows a system 500 comprising a coordinator node 504 and a plurality of training nodes 502. In the illustrated embodiment, a first training node 502a (Training Node 1) and a second training node 502b (Training Node K) are shown. In general, the system 500 may, in general, comprise at least one training node and may, in some examples, comprise many more training nodes than those shown.

The system 500 may form part of a communications network, such as a cellular network. The system may be or comprise the communication system 100.

The coordinator node 504 is configured to (e.g. served) to coordinate the training of a model using machine-learning by the plurality of training nodes 502. The coordinator node 504 may include a processor and a memory (e.g. a non-transitory processor-readable medium). The memory may store instructions (e.g. processor-readable instructions) which, when executed by a processor of the coordinator node 504, cause the coordinator node 504 to perform the operations described herein. The coordinator node 504 may further comprise a network interface. The network interface may be for communicating with one or more other nodes, such as the plurality of training nodes 502. The network interface may comprise any suitable interface such as a transmitter/receiver with an antenna to send and receive wireless transmissions to/from one or more other nodes, an NIC, and/or a computer port (e.g. a physical outlet to which a plug or cable connects), and/or a network socket etc.

The coordinator node 504 may be a node in a communications network. In some examples, the coordinator node 504 may be in a random access network, such as the radio access network (RAN), such as the radio access network 120. The coordinator node 504 may be, for example a TRP such as any of the TRP's 170a, 170b, 170c described above in respective FIGS. 1-4. The coordinator node 504 may be, for example, a base station. The coordinator node 504 may be a UE. The coordinator node 504 may be a Wi-Fi device, such as a Wi-Fi access point (AP). The coordinator node 504 may be an unmanned aerial vehicle (UAV) such as a drone, etc. In some examples, the coordinator node 504 may comprise a core network node. For example, the coordinator node 504 may be a node in a core network, such as the core network 130 described above in respect of FIGS. 1-4. The node in the core network may be, for example, a server or an AI-based function.

For ease of description, the operation of the training nodes 502 is described with reference to a (e.g. a single) training node 502. As such, references to the training node 502 may be taken to refer to any of the plurality of training nodes 502, such as the first training node 502a and/or the second training node 502b. Each of the plurality of training nodes 502 may be the same as one another or different to one another. As such, aspects of the following description which refer to the training node 502 may apply to some or all of the plurality of training nodes 502.

The training node 502 may include a processor and a memory (e.g. a non-transitory processor-readable medium). The memory may store instructions (e.g. processor-readable instructions) which, when executed by a processor of the training node 502, cause the training node 502 to perform the operations described herein. The training node 502 may further comprise a network interface. The network interface may be for communicating with one or more other nodes, such as the coordinator node 504. The network interface may comprise any suitable interface such as a transmitter/receiver with an antenna to send and receive wireless transmissions to/from one or more other nodes, an NIC, and/or a computer port (e.g. a physical outlet to which a plug or cable connects), and/or a network socket etc.

The training node 502 may be any node configured to train the model. The training of the model is discussed in more detail below. The training node 502 may alternatively be referred to as a local node 502. The training node 502 may comprise an electronic device, such as any of the electronic devices 110 described above in respect of FIGS. 1-4. For example, the training node 502 may comprise a user equipment. The training node 502 may include an edge device. The training node 502 may include a sensing device. The training node 502 may comprise, for example, a Wi-Fi device (e.g. a device configured to communicate using a Wi-Fi network), such as Wi-Fi AP. In some examples, the training node 502 may comprise a network device or network node. The training node 502 may, for example, comprise a TRP (e.g. any of the TRPs 170a, 170b, 170c described above in respect of FIGS. 1-4) such as a base station, or an unmanned aerial vehicle (UAV) such as a drone, etc. The training node 502 may, for example, comprise a node in a core network of the communications network, such as a node in the core network 130 described above in respect of FIGS. 1-4. The training node 502 may comprise a server (e.g. in the core network). The training node 502 may comprise an artificial intelligence (AI)-based functionality node.

The model may be any model trainable using a machine-learning process (e.g. a machine-learning algorithm). As such, the model may be referred to as a machine-learning model. The machine-learning model may form part of a larger model (e.g. part of another machine-learning model). The machine-learning model may be any suitable machine-learning model such as, for example, a neural network (e.g. deep neural network), a k-nearest neighbours process, a linear regression process, a logistic regression process, a support-vector machine or any other suitable machine-learning process. The machine-learning model may have one or more parameters. The one or more parameters may include, for example one or more weights and/or one or more biases of the model. The one or more parameters might not be hyperparameters of the machine-learning model. That is, the one or more parameters may be the parameters derived via training of the machine-learning model, rather than the parameters used to control the learning process.

The coordinator node 504 may transmit the machine-learning model to be trained to the training node 502. The coordinator node 504 may broadcast or multicast the machine-learning model to the plurality of training nodes 504. Alternatively, the coordinator node 504 may transmit the machine-learning model to the particular training node 502 individually (e.g. by using one or more unicast transmissions). The transmitted machine-learning model may be referred to as the global or common model since the same machine-learning model may be transmitted to the plurality training nodes 502. Transmitting the machine-learning model to the training node 502 may involve transmitting one or more of structural information of the machine-learning model (e.g. such as one or more layers and/or one or more neural nodes), the parameters of the machine-learning model (e.g. one or more weights and/or biases of the machine-learning model) to the training node 502.

Alternatively, the training node 502 may obtain the machine-learning model through other means (e.g. from another node, such as another training node, or by being preconfigured with the machine-learning model).

The coordinator node 504 may instruct the training node 502 to train the machine-learning model. This instruction may be implicit. For example, the coordinator node 504 may implicitly instruct the training node 502 to train the machine-learning model by sending the machine-learning model to the training node 502. Alternatively, the coordinator node 504 may send an explicit instruction to train the machine-learning model to the training node 502. For example, the coordinator node 504 may send an indication to the training node 502 to train a pre-configured or pre-defined machine-learning model. The explicit instruction may comprise one or more of: higher-layer signaling (e.g. RRC) and dynamic signaling (e.g. DCI, L1 signaling). The explicit instruction may be used to configure one or more AI or machine-learning associated parameters (also referred to as hyperparameters) for the meta-settings.

The receipt of an instruction from the coordinator node 502 to train the machine-learning model at the training node 502, whether implicit or explicit, is an example of a trigger event that may cause the training node 502 to train the machine-learning model. In other examples, the training node 502 may train the machine-learning model responsive to another trigger event occurring. For example, the training node 502 may receive an instruction from another device. In another example, the training node 502 may obtain a particular amount (e.g. quantity) of training data and may train the machine-learning model in response to obtaining that amount of training data (e.g. responsive to obtaining a minimum or sufficient amount of training data to train the machine-learning model). In some examples, the training node 502 may train the model responsive to a threshold time since a previous training round or iteration elapsing. That is, in some examples, each training round or iteration may be performed at particular time intervals (e.g. when a configurable time period has elapsed). The training node 502 may, for example, train the model responsive to a timer since the last training iteration or round expiring.

The training node 502 may train the machine-learning model to determine respective updates to values of parameters of the machine-learning model. The training node 502 may be configured to train the machine-learning model using respective training data, which may also be referred to as local training data, a respective training dataset or training samples. The respective training data may be specific to (e.g. local to, private to or unique to) the training node 502. The respective training data may be stored the training node 502. The respective training data may be obtained (e.g. collected or collated) by the training node 502.

The respective updates may be referred to as local updates. The updates may be referred to as gradients or slopes. A particular update for a parameter may be the difference between an earlier value of the parameter and a new value of the parameter. Alternatively, an update may be the new value of the parameter. The training node 502 may transmit its updates to the coordinator node 504. Thus, each of the training nodes 502 may transmit its respective updates to the coordinator node 504. The coordinator node 504 may determine a common updated machine-learning model based on the updates received from the training nodes 502. The common updated machine-learning model may be so described because it is based on updates received from each of the training nodes 502. As such, it may be described as being common to, or shared by the training nodes 502. The common updated model may also be referred to as a global model. Thus, for example, the coordinator node 504 may combine or aggregate the updates received from the training nodes 502 to determine a common updated model.

Whilst this approach allows for training the model using the computing resources and training data of the training nodes 502, it involves signaling updates to the coordinator node 504 after each iteration of training. As machine-learning models can include a large number of parameters, this can incur significant signaling overhead.

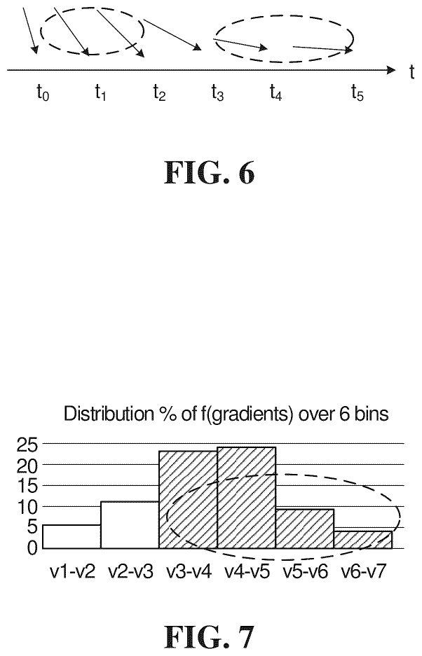

According to aspects of the present disclosure, it may be determined whether at least one of the updates is to be transmitted from a respective training node to a coordinator node based on an evaluation of the training performed by the training node to determine the updates. The evaluation of the training is discussed in more detail below in respect of FIGS. 6-8.

### Training Evaluation

In aspects of the present disclosure, the training performed by a training node to determine updates to values of parameters of a machine-learning model may be evaluated according to a metric. The training node may be the training node 502 or another suitable training node.

In some embodiments, the metric may be based on a characteristic of the updates to the values of the parameters. The characteristic may include a size of the updates. That is, the training may be evaluated based on how much the value of a model parameter (e.g. how much each model parameter) changes as a result of the training.

FIG. 6 illustrates the updates of parameters of a machine-learning model in different (training) rounds or training iteration periods t₀, t₁ . . . t₅ of training of the machine-learning model, respectively, according to embodiments of the disclosure. The updates are illustrated as gradients per iteration period (shown as a vector line) such that the steeper the line, the larger the change in the parameter values as a result of the updates in one training round. As shown in FIG. 6, some rounds are associated with steeper lines than others, indicating that some training rounds result in a larger change to the values of the parameters. For example, the updates for rounds t₁ and t₂ are illustrated by steeper lines than rounds t₄ and t₅, indicating that the updates for rounds t₁ and t₂ result in a larger change in the parameter values than the updates for rounds t₄ and t₅.

In some examples, it may be determined that the update for round t₂ is to be transmitted because the values of the model parameters after training round t₂ are very different to the values of the model parameters from the previous round, t₁. That is, it may be determined that the training performed in round t₂ did have a significant impact on the model parameters, and thus the updates to the parameters do need to be transmitted to the coordinator node for a (partial) contribution on updating the global machine-learning model parameters at the coordinator node.

In some examples, it may be determined that some or all of the updates for round t₅ are not to be transmitted because the values of the model parameters after training round t₅ are close to the values from the previous round, t₄. That is, it may be determined that the training performed in round t₅ did not have a significant impact on the model parameters, and thus the updates to the parameters do not need to be transmitted.

Therefore, it may be determined whether or not to transmit an update to a parameter of a machine-learning model obtained from training the machine-learning model based on the size of the update. The size may be an absolute size. Thus, for example, it may be determined that an update is to be transmitted to the coordinator node 504 responsive to the update satisfying (e.g. exceeding) a threshold value. The threshold value may thus define a minimum size that the update must meet to be transmitted to the coordinator node 504.

In other examples, the size may be a relative size. In some examples, it may be determined whether or not to transmit an update to a parameter obtained from training the machine-learning model based on a size of the update relative to the parameter. Updates that are more than a threshold percentage size of the parameter value may be determined to be transmitted. For example, it may be determined to transmit an update of 2.5 to a parameter value 10 responsive to determining that the update is more than 10% of the size of the parameter value (e.g. because the update is 25% of the parameter value).

In some examples, it may be determined whether or not to transmit an update to a parameter obtained from training the machine-learning model based on a size of the update relative to an earlier update to an earlier value of the parameter. In the example illustrated in FIG. 6, for example, it may be determined not to transmit the update from round t₅ based on a comparison of the updates from rounds t₅ and t₂. More generally, it may be determined than an update is to be transmitted responsive to determining that the update is greater than a threshold, such as a threshold percentage of an earlier update or an average of two or more earlier updates (e.g. two or more earlier transmitted updates). For example, it may be determined to transmit an update that is greater than a threshold percentage (e.g. 50%) of the last update to be transmitted.

Alternatively, it may be determined than an update is to be transmitted responsive to determining that an absolute difference between the update and an earlier update (e.g. the last update to be transmitted) or an average of two or more earlier updates (e.g. the two or more last updates to be transmitted) is greater than a threshold value.

In some examples, it may be determined whether or not to transmit updates based on the size of a group of the updates. The group of the updates may include some or all of the updates from a particular training round or iteration. Any of the approaches described above may be implemented using a function of the group of updates. The function may include any suitable function such as, for example: a total of the updates in the group, a maximum of the updates in the group, a minimum of the updates in the group and/or an average of the updates in the group (e.g. mean or median), for example. Thus, for example, the determination may be made based on a comparison of an average of all the updates to a threshold value. In another example, the determination may be made based on a comparison of the minimum of all the updates to a threshold value. In another example, the determination may be made based on a comparison of the maximum of all the updates to a threshold value. In these examples, if the threshold is satisfied (e.g. exceeded), the updates may be transmitted. If the threshold is not satisfied (e.g. it is not exceeded), the updates might not be transmitted.

In some examples, a subset of the updates from a particular training round may be determined to be transmitted based on a comparison between updates from the particular training round. It may be determined to transmit a subset of the updates from a particular round based on the distribution of the updates. The distribution of the updates may be over a range of configured values or value intervals, for example. The particular subset of updates to be transmitted may be identified based on the distribution of the updates.

This may be illustrated by reference to FIG. 7, which shows a histogram of updates to parameters of a machine-learning model in a training round in an example. The values are binned into six bins: v₁-v₂, v₂-v₃, v₃-v₄, v₄-v₅, v₅-v₆ and v₆-v₇ in which a bin in the range x-y includes any updates with values greater than x and less than y. v₇>v₆>v₅>v₄>v₃>v₂>v₁ such that the bin v₆-v₇ (the right-most bin) includes the largest updates and the bin v₂−v₁ (the left-most bin) includes the smallest updates. In an example, it may be determined to transmit the subset of updates that are in the highest four bins e.g. the updates in bins v₃-v₄, v₄-v₅, v₅-v₆ and v₆-v₇. It may be determined that the updates in the lowest two bins, v₁-v₂ and v₂-v₃, are not to be transmitted.

More generally, it may be determined to transmit a subset of updates in the N highest bins (e.g. the N bins holding the largest updates), in which the updates are binned into the bins according to a predetermined binning scheme (e.g. into bins with predetermined bin ranges or values). The updates may be binned based on their absolute size or based on their size relative to their respective parameter value (e.g. to the parameter value the update is for).

In some examples, the subset of the values to be transmitted may be the largest (e.g. the maximum) update from a plurality of updates determined in a particular training round. In another example, it may be determined to transmit the N largest updates from a particular training round, in which Nis an integer that is greater than 1 (N>1).

In some examples, it may be determined that none of the updates are to be transmitted based on the size of the updates. In an example, it may be determined that none of the updates are to be transmitted based on none of the updates satisfying a threshold value. For example, all of the updates may be less than a minimum threshold value (e.g. they are too small to be transmitted). In another example, a function of the updates may be below a threshold value (e.g. may fail to meet a minimum threshold). For example, the sum or maximum of the updates may be less than a minimum threshold value. In another example, it may be determined that none of the updates are to be transmitted based on a comparison of the updates to earlier updates (e.g. based on differential gradients over history). For example, it may be determined not to transmit any of the updates based on the updates being less than 10% of the size of earlier updates.

Thus, in some embodiments, it may be determined whether or not to transmit an update to a parameter based on the size of the update. This is one example of a characteristic upon which a metric for evaluating training may be based.

In some embodiments, the metric may be based on a fitting status of the updated model obtained by training the machine-learning model. That is, it may be determined whether or not to transmit an update based on a convergence of the updated model, e.g. how well the updated model fits the underlying data.

During training of a machine-learning model, the updated model may be described as being in one of three stages: underfitting, good fitting and overfitting. Underfitting may indicate that more training data is needed. Underfitting may indicate that the updated model fails to accurately capture an underlying relationship, trend or behaviour in the training data. At the good fitting stage, training of the model may almost complete. That is, the parameters of the model may be at or close to their optimal values. This may alternatively be referred to as the model converging or being at convergence. In the overfitting stage, the updated model may have been trained too much. For example, the updated model may be overly focussed on unnecessary details or noise in the training dataset.

In some examples, the metric may indicate whether the updated model is underfitting, overfitting or good fitting. In the context of the present disclosure, good fitting may be defined as the regime in which the updated model is neither underfitting nor overfitting.

In some examples, it may be determined that at least one of the updates for a training round is to be transmitted responsive to determining that the updated model is underfitting. In some examples, it may be determined that all of the updates for a training round are to be transmitted responsive to determining that the updated model is underfitting. Underfitting indicates that the model parameters are not converged, so further training is needed. This suggests that useful information is being returned in the training rounds and should be shared with the coordinator node for aggregation with updates from other training nodes. As a result, by causing at least some, or even all, of the updates to be transmitted to the coordinator node when the updated model is underfitting, the global (e.g. common) model being developed based on the update from the training node can be trained more quickly and accurately.

In some examples, it may be determined that at least some of the updates or, in particular, a subset of the updates, for a training round should be transmitted responsive to determining that the updated model is good fitting (e.g. is neither underfitting nor overfitting). In the good fitting regime, the model parameters are approaching or are at convergence. As some of the model parameters may have already converged, it might not be necessary to transmit updates to those parameters. That is, the transmission of parameters that are at or near convergence may be omitted without significantly impacting the development of the global (e.g. common) model. By determining to transmit only a subset of the updates, network resources can be saved whilst still allowing the global model to be developed quickly and efficiently.

It will be appreciated that there are various ways in which the subset of the updates that is to be transmitted may be determined. In some examples, the subset of the updates may be selected based on a characteristic of the updates, such as the size. For example, any of the approaches described above for determining whether an update should be transmitted based on its size (e.g. absolute size or relative size) may be used.

In an example, the subset of the updates may be determined based on a predetermined binning scheme. For example, the updates may be binned according to a configured number of bins and bin values (e.g. from small to large) using a histogram, and the updates that are binned in largest-valued bins (e.g. bins larger than a threshold value y), each having a predetermined number of gradients above a threshold percentage x %, may be transmitted.

In some examples, it may be determined that none of the updates for a training round should be transmitted responsive to determining that the updated model is overfitting. In the overfitting regime, the updated model may perform worse than the model before the updates. As a result, preventing transmission of updates when the model is overfitting can maintain the accuracy (e.g. prevent the degradation of) the global (e.g. common) model. That is, determining that none of updates are to be transmitted when the updated model is overfitting can prevent the training node from making a negative contribution to the development of the global model. In addition, since none of the updates are to be transmitted, network resources that would have otherwise been used for communicating the updates can be saved.

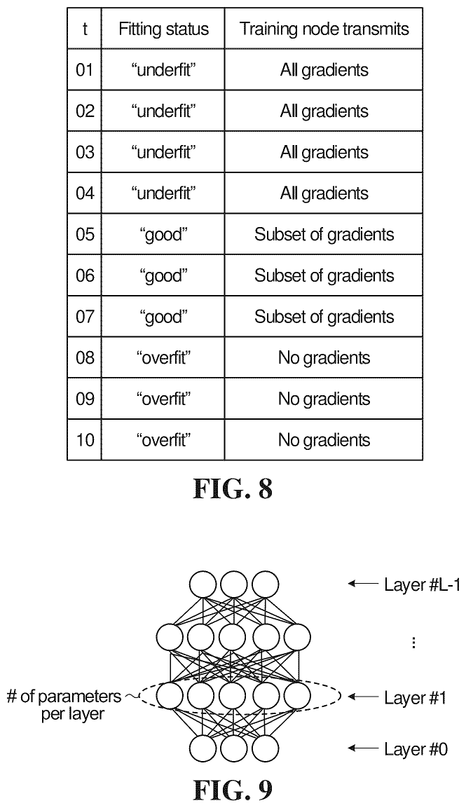

An example implementation is shown in FIG. 8, which indicates the fitting status for an updated model at training rounds t=01, 02, . . . 10. In rounds t=01-04, the updated model is underfitting (“underfit”). Therefore, it is determined that the training node is to transmit all of the updates (referred to as “gradients” in the drawings). In rounds t=05-07, the updated model is good fitting (“good”). Therefore, it is determined that the training node is to transmit a subset of the updates. In rounds t=08-10, the updated model is overfitting (“overfit”). Therefore, it is determined that the training node is to transmit a none of the updates.

Therefore, it may be determined whether or not to transmit an update based on a fitting status of the updated model.

It will be appreciated that there many ways for determining the fitting status of an updated model. In some examples, the fitness status of the updated model may be determined using validation, or test data. The validation data may have the same structure and/or format as the data used to train the model (e.g. as the training data). The training data may include first input data and first expected output data, in which the first expected output data is the desired result from inputting the first input data to the trained machine-learning model. The validation data may include second input data and second expected output data, in which the second expected output data is the desired result from inputting the second input data to the trained machine-learning model. That is, the training data and the validation data may comprise respective labelled datasets, in which inputs for the machine-learning model are labelled with a corresponding desired or expected model output. In some examples, the training data and the validation data may be obtained by splitting data that would have otherwise been used for training the machine-learning model (e.g. data obtained at the training node 502 for training the machine-learning model) into the training data and the validation data.

The fitness status of the updated model may be determined by inputting the first input and the second input into the updated model and comparing the outputs to the first expected output data and the second expected output data. The difference between the outputs from the model and the corresponding expected first and second outputs may be compared to a threshold. When the differences for both the training data and the validation data exceed the threshold (e.g. the prediction errors from both groups are large), the fitting status may be determined to be underfitting. When the differences for both the training data and the validation data are less than the threshold (e.g. the prediction errors from both groups are small), the fitting status may be determined to be good fitting (e.g. neither underfitting nor overfitting). When the difference for the training data is less than the threshold but the different for the validation data is greater than the threshold (e.g. the prediction error from the training data is small but the prediction error from the validation data is large), the fitting status may be determined to be overfitting. The threshold may be a configurable value. The training data may alternatively be referred to as a trained group data. The validation data may alternatively be referred to as testing group data.

Typically, underfitting may occur at the beginning of training. Over rounds of training, the updated model may reach the good fitting and then overfitting stages. However, in some situations, the updated model may return to the underfitting and/or good fitting stages after overfitting. This may occur when, for example, the training node obtains new training data for training the model. It will be appreciated that different training nodes may reach different fitting statuses at different times due to their independent (e.g. diverse) training data sources.

Thus, the training performed by a training node to determine updates to values of parameters of a machine-learning model may be evaluated according to a metric. The metric may be based on the fitting status or a characteristic of the updates. In some examples, the metric may be based on the fitting status and a characteristic of the updates. That is, the training may be evaluated based on the fitting status and a characteristic of the updates.

In an example, it may be determined to transmit some (e.g. a subset) of the updates based on the fitting status associated with the updates being good fitting (e.g. not underfitting or overfitting) and the size of a proportion of the updates satisfying a threshold value. For example, it may be determined that a subset of the updates is to be transmitted responsive to the fitting status being good fitting and 10% of the updates being above a threshold value T. If at least one of these criteria is not met (e.g. the fitting status is not good and/or fewer than 10% of the updates are above the threshold T), then it may be determined that all of the gradients are to be transmitted.

In some examples, the metric may be based on a structure of the machine-learning model. The metric may be based on a characteristic of the updates and the structure of the machine-learning model. In an example, the machine-learning model may have a plurality of layers it may be determined to transmit some (e.g. a subset) of the updates based on a proportion of the layers in the machine-learning model having updates with values that satisfy (e.g. are above) a threshold value T. This may be particularly appropriate for a machine-learning model that comprises a neural network, such as a deep neural network (DNN). For example, it may be determined to transmit some (e.g. a subset) of the updates for a DNN based on more than 20% of layers in the DNN having updates with values that are above a threshold value. If fewer than 20% of the layers have updates above the threshold T, then it may be determined that all of the gradients are to be transmitted.

### Transmission Mode

As described above, it may be determined that at least some or none of the updates are to be transmitted. In particular embodiments, it may be determined that some (e.g. a subset), all or none of the updates are to be transmitted. These may be referred to as different transmission modes. In some embodiments there may be two transmission modes. In an embodiment, the two transmission modes may comprise: at least some updates are to be transmitted or none of the updates are to be transmitted. In another embodiment, the two transmission modes may comprise: all or some (e.g. a subset) of the updates are to be transmitted. In other embodiments there may be three transmission modes: all, some or none of the updates are to be transmitted. In the latter case, the three transmission modes may be referred to as Type 1 (all updates are to be transmitted, e.g. full update transmission), Type 2 (only some updates are to be transmitted, e.g. partial update transmission) and Type 3 (none of the updates are to be transmitted e.g. no update transmission) respectively. In general, there may be two or more transmission modes. The transmission modes may be based on a system configuration, pre-configuration, or/and pre-definition.

The transmission mode may be determined (e.g. selected) based on the metric described above (e.g. based on a fitting status, a characteristic of updates and/or a structure of the model). In some examples, the metric may be based on a combination of fitting status and a characteristic of updates to the values of the parameters of the machine-learning model.

The transmission mode may be indicated to the coordinator node 504 or the training node 502.

The transmission mode be determined at the training node 502 and indicated to the coordinator node 504. The training node 502 may, for example, determine a transmission mode based on, e.g. the fitting status of the updated model, and transmit an indication of the transmission mode to the coordinator node 504. For example, the training node 502 may determine that the model is overfitting and indicate to the coordinator node 504 that none of the updates are to be transmitted. In another example, the training node 502 may determine, based on the size of the updates, that not all of the updates are to be transmitted and indicate, to the coordinator node 504, that only a subset of the updates is to be transmitted.

Sending such an indication to the coordinator node 504 may allow the coordinator node 504 to re-allocate, for another purpose or to another node, network resource that were previously allocated to the training node 502 for transmission of updates. This allows network resources to be used more efficiently.

Alternatively or furthermore, the transmission mode may be determined at the coordinator node 504 and indicated to the training node 502. The training node 502 may, for example, indicate to the coordinator node 504 an evaluation of the training of the machine-learning model. The evaluation may be based on the metric. The coordinator node 504 may determine the transmission mode based on the evaluation and indicate the transmission mode to the training node 502. This can allow the coordinator node 504 to adapt the transmission of updates based on the availability of network resources.

In some examples, the transmission mode indicator may be sent each time the transmission mode is determined. In other examples, the transmission mode indicator might only be sent when the transmission mode changes. Thus, for example, the transmission mode indicator may be sent responsive to determining (e.g. at the training node 502 or the coordinator node 504) that the transmission mode is to transmit none of the updates, when the previous transmission mode was to transmit some of the updates. In another example, the training node 502 may initially be configured to transmit all the updates (e.g. starting from a legacy configuration) and the transmission mode indicator may only be sent when the transmission mode changes (e.g. to partial or none). For example, the transmission mode indicator may only be sent when the transmission mode is to change to partial transmission (e.g. based on the fitting status being good fitting). By only sending the transmission mode indicator when the transmission mode changes, transmission resources and/or signaling overhead over the air-link can be reduced.

The transmission mode may be indicated using a transmission mode indicator, which may also be referred to as a local indicator (LI). The transmission mode indicator may be in any suitable format.

The transmission mode indicator may be included in a message. The message may include one or more of the following: an indicator of whether or not the transmission mode is changing, the transmission mode indicator, a parameter indicator (discussed in more detail below), information for a scheduling request (SR), information for a buffer status report (BSR), an indication of a modulation and coding scheme (MCS) and one or more hyperparameters of the machine-learning model (e.g. one or more auxiliary parameters or meta-info for training of the machine-learning model). In some examples, the transmission mode indicator may be included in an SR (which may be referred to as an enhanced SR). For example, one or two bits in the SR may be used to indicate the transmission mode and/or that the transmission mode is changing. The SR may be transmitted via a control channel. The SR may be piggybacked (e.g. transmitted with) a data channel. In some examples, the transmission mode indicator may be included in a BSR. For example, one or two bits in the BSR may be used to indicate the transmission mode and/or that the transmission mode is changing. The BSR may also indicate the parameter indicator (discussed in more detail below). The BSR may be transmitted via a control channel. The BSR may be piggybacked (e.g. transmitted with) a data channel.

The message may be a Random Access Channel (RACH) message. In some examples, the transmission mode indicator may be indicated using one or more preambles for indicating a transmission mode and/or a change in transmission mode. The one or more preambles (e.g. dedicated preambles) may or might not be specific to the training node 502. For dedicated preambles specific to the training node 502, a (e.g. one) dedicated preamble may be used to perform RACH process as well as indicate one of the transmission modes. Furthermore or alternatively, the RACH message may be, for example, a RACH Message A (e.g. in a 2-step RACH process). In another example, the RACH message may be a RACH Message 3 (e.g. in a 4-step RACH process). In some examples, the coordinator node 504 may transmit the transmission mode indicator to the training node 502 in a RACH response message. For example, the coordinator node 504 may transmit the transmission mode indicator in a RACH response message comprising a grant scheduling one or more resources (e.g. in Message B in a 2-step RACH process or in Message 2 in a 4-step RACH process) to be used by the training node 502 for transmission (e.g. for transmission of the updates).

In some examples, the message may be a Physical Uplink Shared Channel (PUSCH) message from the training node 502 to the coordinator node 504. Thus, the transmission mode indicator may be piggybacked in a PUSCH message, e.g. in a form of BSR or enhanced SR. The PUSCH message may, in addition to or instead of the inclusions described above, include any suitable uplink traffic.

In some examples, the message to indicate a transmission mode may be a control channel message, such as a Physical Uplink Control Channel (PUCCH), Physical Downlink Control Channel (PDCCH) or Artificial Intelligence (AI) control channel message. The training node 502 may, for example, use uplink control information (UCI) to indicate the transmission mode. The UCI may be a new UCI (e.g. that uses 2 bits). The coordinator node 504 may, for example, use downlink control information (DCI) to indicate the transmission mode. The DCI may be a new DCI (e.g. that uses 2 bits).

In some examples, the message may be downlink acknowledgement (DL-ACK) message. The coordinator node 504 may, for example, transmit the transmission mode indicator to the training node 502 in a DL-ACK message. The DL-ACK message may be transmitted in a shared channel (e.g. a group-common channel shared with another training node or system), such as a sensing channel. The DL-ACK message may be sent in a channel specific to the machine-learning model being trained (e.g. a channel specific to the coordinator node 504 and the training nodes 502).

In some examples, the transmission mode may be indicated using a sensing signal. For example, the transmission mode may be indicated by transmitting a sensing signal comprising a waveform that indicates the transmission mode. In another example, the transmission mode may be indicated by transmitting a sensing signal comprising a reference signal (RS) that indicates the transmission mode. In some examples, the transmission mode indication (e.g. via the sensing signal or any other message/signaling) may be separate from (e.g. before) the transmission of the updates (if any). Thus a time period between the two transmissions may be specified. For grant-free transmissions, one or more scheduling-free network resources (e.g. one or more time-frequency resources, such as one or more periodic time-frequency resources) may have been configured. An advancing time, or time advance, (to transmit the mode indication) may be pre-configured relative to each grant-free transmission resource. The time advance may indicate when the transmission mode indication is to be sent relative to the one or more scheduling-free network resources. For grant-based (e.g. scheduled) transmissions, each (absolute) transmission time for the mode indication may be predefined, pre-configured or semi-statically configured.

Identifying which Updates are to be Transmitted

In some embodiments, the training node 502 may identify, to the coordinator node 504, which updates are to be transmitted. This may be particularly appropriate when a subset of the updates is to be transmitted. The training node 502 may transmit a parameter indicator to the coordinator node 504, in which the parameter indicator identifies the subset of the updates that are to be transmitted from the training node 502. The parameter indicator may have a pre-defined or pre-configured format. The parameter indicator may have one or more pre-defined or pre-configured transmission parameters. In this way, the coordinator node 504 may decode the parameter indicator to determine the parameters of the machine-learning model for which updates are transmitted. The parameter indicator may be received at the coordinator node 504 with the updates, for example. The coordinator node 504 may use this information to allocate network resources to the training node 502 or, for example, to re-allocate resources that were previously assigned to the training node 502 for another purpose (e.g. to another node). For example, the training node 502 may transmit, to the coordinator node 504, one or more of: a request for a transmission mode, a traffic size, a MCS, a channel selection, and an indication of an evaluation of the training (e.g. training performance results). The coordinator node 504 may use the information to allocate network resources to the training node 502. In this way, for example, the coordinate node 504 may be able to re-allocate resources that were previously assigned to the training node 502 for another purpose (e.g. to another node, such as a UE).

The coordinator node 504 may use the information to determine when (or whether to) to try and detect the updates transmitted by the training node 502. This may be particularly appropriate when the training node 502 is configured to transmit using one or more scheduling-free resources. Indicating, to the coordinator node 504, which updates are to be transmitted in which pre-configured resource (e.g. by a resource configuration index) may allow for more efficient use of network resources, as well as more efficient use of processing at the coordinator node 504.

The coordinator node 504 may use the parameter indicator received from the training node 502 (and/or a request for a transmission mode, a traffic size, a MCS, a channel selection, and an indication of an evaluation of the training as described above) to determine when (and/or whether to) to try and the detect updates transmitted by the training node 502. This may be particularly appropriate when the training node 502 is configured to transmit using one or more scheduling-free resources. Indicating, to the coordinator node 504, which updates are to be transmitted (e.g. in which pre-configured resource) may allow for more efficient use of network resources, as well as more efficient use of processing at the coordinator node 504. This may be indicated using a resource configuration index, for example.

In some examples, the parameter indicator may identify the machine-learning model. For example, the parameter indicator may comprise an index. The index may be for a family of machine-learning models. The coordinator node 504 and/or the training node 502 may be configured to identify the machine-learning model by looking up the index in a look-up table. This may be particularly appropriate when the coordinator node 504 and/or the training node 502 are configured to train a plurality of machine-learning models. As a result, the parameter indicator may identify one or more parameters in a machine-learning model and/or one or more machine-learning models from a family of machine-learning models.

In some examples, the parameter indicator may be based on the structure of the machine-learning model. The machine-learning model may contain a plurality of layers having respective parameters and the parameter indicator may indicate the layers for which updates will be transmitted. The parameter indicator may thus indicate one or more layers of the machine-learning model. This may be particularly appropriate for a machine-learning model that comprises a neural network such as a DNN. The parameter indicator may comprise, for example a field length indicating how many layers are to be transmitted and identification of the layer(s) to be transmitted. This may be referred to as Format 1, in which the parameter indicator may be based on layer information only. The field length may be a fixed number of bits and the identification of the layer(s) may be a variable length field. The identification of the layer(s) may comprise a list of the layers to be transmitted (e.g. comprising an identifier for each layer that is to be transmitted) or another means of identifying the layers. For example, the identification of the layer(s) may comprise a bitmap, in which layers to be transmitted are associated with, e.g. a 1 and layers that are not to be transmitted are associated with a 0 (or the other way around). For example, for a machine-learning model having 100 layers, of which 10 have updates that are to be transmitted, the parameter indicator may comprise a field length=10 and a layer index [0˜9] indicating which of the layers are to be transmitted using a bitmap or a list. In some examples, he identification of the layer(s) may comprise a list of the layers not to be transmitted (e.g. comprising an identifier for each layer that is not to be transmitted). This may save signaling overhead when fewer than 50% of the layers are to be transmitted.

The parameter indicator may indicate one or more parameters in a respective layer for which an update is to be transmitted in each of the indicated layers. This may be in addition to indicating one or more layers of the machine-learning model. This may be referred to as Format 2, in which the parameter indicator may be based on layer information and update (e.g. gradient) information. The parameter indicator may comprise, for example, a first field length indicating how many layers are to be transmitted and a second field length indicating, for each layer, how many updates are to be transmitted (e.g. the number of parameters in a layer for which updates are to be transmitted). The parameter indicator may further comprise, for each layer, identification of the updates to be transmitted. The identification of the updates to be transmitted may be referred to as an update indicator or a gradient indicator. The identification of the updates to be transmitted may be a variable length field. The identification of the updates to be transmitted may comprise a list of updates, a bitmap, a start and length indicator (e.g. an SLIV scheme), or any suitable identification.

An example of using the parameter indicator to indicate one or more layers of the machine-learning model and, for each of the indicated layers, one or more parameters for which an update is to be transmitted may be described with reference to FIG. 9 and Table 1.

FIG. 9 shows the structure of a machine-learning model that has L layers, in which each layer has one or more parameters. As shown in Table 1, each layer may be assigned a layer index, l, and each parameter in a respective layer may be assigned a parameter index i. The number of parameters in each layer, Kₗ for l=1, 2 . . . L−1, may be the same or may be different.

TABLE 1

| Layer index (l) | Parameter index (k) | Note |
|---|---|---|
| 0 | 0, 1, . . . , k, . . . , K₀ − 1 | Different sets of |
| | | parameter indices can |
| 1 | 0, 1, . . . , k, . . . , K₁ − 1 | be indicated by, e.g. |
| | | SLIV, as an option |
| . | . | |
| . | . | |
| . | . | |
| L − 1 | 0, 1, . . . , k, . . . , K_{L} − 1 | |

For this example, the parameter indicator may comprise a first field length indicating how many of the L layers are to be transmitted and, for each layer, a second field length indicator indicating how many updates for the Kₗ parameters are to be transmitted. The parameter indicator may further comprise indices of the layers to be transmitted and, for each of the layers to be transmitted, indices of the respective parameters for which updates are to be transmitted. In an example, a machine-learning model may have 16 layers (e.g. L=16) in which each layer has 16 parameters. The parameter indicator may comprise 4 bits. If there are only two layer gradients to send, the parameter indicator may use Format 2 comprising a layer x, a number of updates, and an update list, such as {‘0001’, the layer msg length in bits/Bytes, {starting and length of parameters}; ‘1111’, the layer msg length in bits/Bytes, {starting and length of parameters}}.

The parameter indicator may indicate one or more groups of parameters for which updates are to be transmitted. The parameters of the machine-learning model may be grouped into a plurality of groups and the parameter indicator may comprise at least one of the plurality of groups for which updates are to be transmitted. The plurality of groups may be pre-configured or predefined. The groups may comprise the layers described above. Thus, a layer may be considered to be a group of parameters. Alternatively, a group may comprise two or more layers (e.g. may be a group of layers).

The parameter indicator may thus indicate at least one of plurality of groups into which the parameters of the model are grouped. The parameter indicator may comprise, for example a field length indicating how many groups are to be transmitted and identification of the group(s) to be transmitted. This may be referred to as Format 3, in which the parameter indicator may be based pre-configured/predefined grouping information over layers and/or updates (e.g. gradients). The identification of group(s) may comprise a list of group indices (e.g. identifiers, such as indexes, identifying each of the groups to be transmitted), a bitmap, or a start and length indicator, for example. The field length may be a fixed number of bits. The identification of group(s) may be a variable length field. For example, for a machine-learning model having parameters grouped into 5 groups, of which 2 have updates that are to be transmitted, the parameter indicator may comprise a field length=2 and a group index indicating which of the groups are to be transmitted using a bitmap.

In general, the parameter indicator may use hierarchical indexing to identify which updates are to be transmitted. The hierarchical indexing (e.g. the particular scheme or regime) may be known to both the coordinator node 504 and the training node 502. The above examples are examples of using hierarchical indexing to identify which update are being transmitted. In general, any suitable hierarchical indexing method may be used.

In some examples, the parameter indicator may be transmitted in a standalone message. In other examples, the parameter indicator may be transmitted in a message with other information. For example, the parameter indicator may be included as a header in a message. The parameter indicator may be referred to as header information (HI), for example. The parameter indicator may be used to indicate, to the coordinator node 504, the parameters of the machine-learning model for which updates are to be transmitted. This may be referred to as partial data indication with header information.

In particular examples, the parameter indicator may be transmitted in the same message as one or more of: the transmission mode indicator and the updates. Thus two or more of the parameter indicator, transmission mode indicator and the updates may be transmitted with the same occasion. The parameter indicator and/or the transmission mode indicator may be encoded separately to the updates. This may allow the coordinator node 504 to decode the transmission mode indicator and/or the parameter indicator before the updates.

In some examples, the parameter indicator may be transmitted in a message including one or more of the following: a transmission mode indicator, an indicator of whether or not the transmission mode is changing, information for a scheduling request (SR), information for a buffer status report (BSR), an MAC header, an indication of a modulation and coding scheme (MCS) and one or more hyperparameters associated with training of the machine-learning model. For example, the parameter indicator may include one or more of these on top of the indication of parameters of the machine-learning model.

In some examples, the message including the parameter indicator may be a Physical Uplink Shared Channel (PUSCH) message from the training node 502 to the coordinator node 504. Thus, the transmission mode indicator may be piggybacked in a PUSCH message. The PUSCH message may, in addition to or instead of the inclusions described above, include any suitable uplink traffic. The transmission mode indicator may replace an SR and/or BSR that would otherwise be included in the PUSCH message. In some embodiments, the parameter indicator may be included as an MAC (sub-) header, such as an MAC sub-header, of data (e.g. the updates) in a transport block to be transmitted. The data may comprise actual traffic, for example.

In some examples, the message including the parameter indicator may be a control channel message, such as a Physical Uplink Control Channel (PUCCH), Physical Downlink Control Channel (PDCCH) or Artificial Intelligence (AI) control channel message. The training node 502 may, for example, use uplink control information (UCI) to indicate the parameter indicator. The UCI may be a new UCI (e.g. that uses 2 bits). The coordinator node 504 may, for example, use downlink control information (DCI) to indicate the parameter indicator. The DCI may be a new DCI (e.g. that uses 2 bits). In some embodiments, an indication of transmission mode for partial updates transmission (e.g. transmission of a subset of updates) can be transmitted in one of these control channels, while a parameter indicator may be transmitted with the updates in a data channel such as a PUSCH channel in a Uu link or physical sidelink shared channel (PSSCH) channel in sidelink.

In some examples, the message may be downlink acknowledgement (DL-ACK) message. The coordinator node 504 may, for example, transmit the transmission mode indicator to the training node 502 in a DL-ACK message. The DL-ACK message may be transmitted in a shared channel (e.g. shared with another system), such as a sensing channel. The DL-ACK message may be sent in a channel specific to the machine-learning model being trained (e.g. a channel specific to the coordinator node 504 and the training nodes 502).

In some examples, the parameter indicator may be indicated using a sensing signal. For example, the parameter indicator may be indicated by transmitting a sensing signal comprising a waveform that indicates the transmission mode. In another example, the parameter indicator may be indicated by transmitting a sensing signal comprising a reference signal (RS) that indicates the transmission mode.

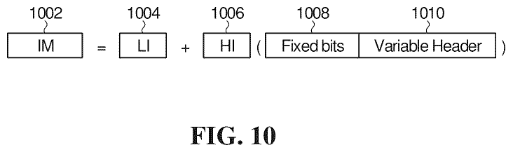

An example message format for transmitting the parameter indicator with the transmission mode indicator is shown in FIG. 10. FIG. 10 shows the format for an indication message (IM) 1002 comprising local indicator (LI) 1004 and header information (HI) 1006. This may be referred to as format notation on transmission mode indication and the structure (parameters) of the machine-learning model. The HI 1006, which includes fixed bits 1008 and variable header 1010, may be an example of the parameter indicator described above. The LI 1004 may be an example of the transmission mode indicator described above.

In some examples, the LI 1004 and the HI 1006 (e.g. the indication message 1002) may be transmitted in a same channel. The same channel may be a control channel or a data channel. This may be particularly appropriate when there is no separate (control or data) channel to transmit LI (e.g. transmission mode indicator). For example, the IM 1002 may be transmitted in a specific time-frequency resource location within one or more scheduling-free resources (e.g. within preconfigured GF resources) to indicate to the coordinator node 504 on a partial transmission of the updates.

The LI 1004 may comprise 2 bits, for example. The HI 1006 and the LI 1004 may be independently encoded. In this example, the HI 1006 comprises fixed bits 1008 for indicating how many layers are to be transmitted (e.g. the length of the variable header 1010). The fixed bits 1008 may thus comprise the field length described above. The fixed bits 1008 may be encoded according to a predefined modulation and coding scheme (MCS). The fixed bits 1008 may, in addition to indicating how many layers are to be transmitted, include one or more of: an indication of an MCS, one or more hyperparameters of the machine-learning model, etc. The variable header 1010 may indicate (e.g. identify) the layers to be transmitted.

In some examples, the HI 1006 may indicate which layers are not to be transmitted (e.g. in the fixed bits 1008). This may be particularly appropriate in examples in which updates are to be transmitted for fewer than 50% of the parameters. By indicating which layers are not to be transmitted, the coordinator node 504 can indirectly be made aware of which layers are to be transmitted whilst using minimal signaling resources.

In examples in which no updates are to be transmitted or all the updates to be transmitted, the HI 1006 may be omitted from the IM 1002. That is, IM=LI. This may apply when the transmission mode is Type 1 or Type 3 as described above.

In which examples in which some, but not all, of the updates are to be transmitted, both the HI 1006 and LI 1004 may be included in the IM 1002. That is, IM=LI+HI as shown in FIG. 10. In particular examples, the IM 1002 may be transmitted with (e.g. multiplexed with) the updates themselves. That is, the training node 502 may transmit the IM 1002 and the updates in the same message. This has the advantage of identifying the parameters for which updates are to be transmitted to the coordinator node 504 without requiring any additional signaling or resources for the indication.

Alternatively, the HI 1006 may be omitted from the IM 1002 (e.g. IM=LI) in examples in which some, but not all, of the updates are to be transmitted and the LI 1004 reporting can map to the unique selection on the transmitted updates based on a pre-determined rule known to the coordinator node 504 (e.g. a pre-configured rule).

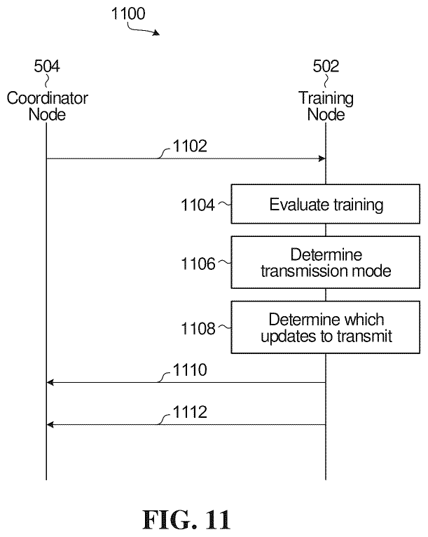

The determination of which updates to transmit from the training node 502 to the coordinator node 504 may be made at the training node 502, the coordinator 504 or distributed across both the training node 502 and the coordinator node 504. This is discussed in more detail below in respect of FIGS. 11-16, which relate to signaling between the coordinator node 504 and the training node 502. As with the foregoing description, references to the training node 502 in the following description may be taken to refer to any of the plurality of training nodes 502 (e.g. to the first training node 502a and/or the second training node 502b).

### Signaling

FIG. 11 is a diagram illustrating a method 1100 performed by the coordinator node 504 and the training node 502 according to embodiments of the disclosure.

The method 1100 may begin with the coordinator node 504 configuring, in step 1102, the training node 502 with one or more scheduling-free network resources. The one or more scheduling-free network resources are for (e.g. are reserved for) the training node 502 to use to transmit, to the coordinator node 504, updates to values of parameters of the machine-learning model. The one or more scheduling-free network resources may comprise time-frequency resources, for example. The one or more scheduling-free network resources may alternatively be referred to as configured grant or grant-free resources. The training node 502 node may transmit to the coordinator node 504 using the scheduling-free network resources without sending an SR to the coordinator node 504 and receiving a scheduling grant.

The coordinator node 504 may the coordinator node 504 may configure the training node 502 with a metric associated with training of the machine-learning model. This may be performed in accordance with step 1304 described below. The coordinator 504 may thus transmit configuration signaling to the training node 502 indicating the metric. The coordinator node 504 may transmit the configuration signaling in step 1102 (e.g. in the same message as the configuration of the one or more scheduling-free resources) or in a different message. The metric may be the metric described above in respect of FIGS. 6-8, for example. The metric may comprise at least one of: an evaluation parameter for evaluation of the training, a rule for deciding whether or not an update is to be transmitted and a threshold for determining which of the updates is to be transmitted. The metric may be for evaluation of the training performed by the training node 502.

Step 1102 may be performed before, after, or during the training of the machine-learning model by the training node 502 (not illustrated). The training node 502 may train the machine-learning model to obtain an updated machine-learning model with updates to values of parameters of the machine-learning model. The training of the machine-learning model by the training node 502 may be performed as described above in respect of FIG. 5.

In step 1104, the training node 502 may evaluate the training associated with the updates using a metric. The training node 502 may be preconfigured with the metric. Alternatively, the training node 502 may have received the metric (e.g. from the coordinator node 504). The metric may be the metric described above in respect of FIGS. 6-8. For example, the training node 502 may, in step 1104, determine a fitting status of the updated model. In another example, the training node 502 may, in step 1104, determine the proportion of the updates that are above a minimum threshold value.

In step 1106, the training node 502 may determine a transmission mode based on the metric. The transmission mode may be determined as described above. The rest of the method 1100 may depend on the transmission mode determined in step 1106. The rest of the method 1100 will be described in the context of examples in which the transmission mode may be that all (Type 1), only some (Type 2) or none (Type 3) of the updates are to be transmitted, although it will be appreciated that it could be adapted for other transmission modes.

In an example, the training node 506 may, in step 1106, determine that the transmission mode is to transmit only some (e.g. a subset) of the updates. The method 1100 may then proceed to step 1108, in which the training node 502 may determine which of the updates to transmit. That is, the training node 502 may determine a subset of the updates to transmit to the coordinator node 504. The training node 502 may determine which of the updates to transmit using any of the methods described above to for determining the subset of the updates to transmit to the coordinator node 504. The training node 502 may make the determination in step 1108 based on the metric, for example. In particular examples, the training node 502 may determine the transmission mode based on the fitness status of the updated model in step 1108 and determine which of the updates to transmit in step 1108 based on a characteristic (e.g. the size) of the updates to the values of the model parameters.

Alternatively, the training node 502 may, in step 1106, determine that the transmission mode is to transmit all of the updates (e.g. Type 1 as described above) and step 1108 may be omitted.

In yet a further alternative, the training node 502 may, in step 1106, determine that the transmission mode is to transmit none of the updates (e.g. Type 3 as described above) and step 1108 may be omitted.

In step 1110, the training node 502 may transmit a transmission mode indicator to the coordinator node 504, indicating the transmission mode determined in step 1106. The transmission mode indicator may be as described above. For example, the transmission mode indicator may comprise the LI described above. Although step 1110 is shown in FIG. 11 as being performed after step 1106, it will be appreciated that, in general, step 1110 may be performed before, during or after step 1108. In some examples, step 1110 may be performed responsive to step 1106.

In some examples, step 1110 may be omitted. For example, the training node 502 may determine, in step 1106, that the transmission mode is unchanged (e.g. the same as in a previous iteration of the method 1100 or the same as previously configured by the coordinator node 504). The training node 502 may, in response to determining that the transmission mode is unchanged, determine not to transmit a transmission mode indicator in step 1110.

In examples in which the transmission mode is to transmit none of the updates (e.g. Type 3 as described above), the method 1100 may end in step 1106 (with the determination of the transmission mode). Alternatively, the method 1100 may continue to step 1110 with the indication of the transmission mode. The training node 502 may thus indicate, in step 1100 that no updates are to be transmitted. The training node 502 may transmit a transmission mode indicator comprising a single bit or two bits, for example. The number of bits used for the transmission mode indicator may depend on how many transmission modes are to be used (e.g. by configuration). After the coordinator node 504 detects and decodes the transmission mode indicator, it might not try to detect and process any data traffic in the one or more scheduling-free resources, thus saving the coordinator node 504 processing power and time. Without the transmission mode indicator, the coordinator node 504 may try to detect and process any possible data traffic in the one or more scheduling-free resources, which may waste processing power and time at the coordinator node 504. In some examples, the coordinator node 504 may reallocate the one or more scheduling-free resources configured in step 1102 to another node or to another purpose (e.g. for sensing). This can allow network resources to be used more efficiently.

In examples in which the transmission mode is to transmit all or some of the updates (e.g. Type 1 or 2 as described above), the method 1100 may proceed to step 1112, in which the training node 502 may transmit, to the coordinator node 504, at least one of the updates in accordance with the transmission mode. The training node 502 may transmit the at least one of the updates using the scheduling-free resources configured in step 1102. The training node 502 may use some or all of the scheduling-free resources for the transmission.

In examples in which the transmission mode is determined, in step 1106, that all of the updates are to be transmitted, the training node 502 may, in step 1112, transmit all of the updates to the coordinator node. The training node 502 may, for example, transmit all of the updates to the coordinator node 504 responsive to determining that the transmission mode is Type 1 (all) in step 1106.

Alternatively, the training node 502 may transmit only some of the updates (e.g. a subset of the updates) to the coordinator node 504 responsive to determining that only some of the updates are to be transmitted in step 1106. The training node 502 may, for example, transmit some of the updates to the coordinator node 504 responsive to determining that the transmission mode is Type 2 (partial updates) in step 1106. The training node 502 may transmit the updates identified in step 1108 to the coordinator node 504. That is, the training node 502 may transmit the subset of updates identified in step 1108 as being for transmission to the coordinator node 504.

The training node 502 may transmit a parameter indicator to the coordinator node 504, in which the parameter indicator identifies the subset of the updates that are being transmitted to the coordinator node 504. The parameter indicator may be as described above. The parameter indicator may include the HI as described above, for example. The training node 502 may include the parameter indicator with the at least one of the updates transmitted in step 1112 (e.g. in the same message). For example, the training node 502 may transmit the parameter indicator as a header in a message containing the at least one of the updates. The header may be an MAC header, for example. The header may be a higher layer header.

Alternatively, the training node 502 may transmit the parameter indicator in a separate message. The separate message may be sent before, at the same time or after the at least one of the updates. The training node 502 may transmit the parameter indicator and the transmission mode indicator in the same message (e.g. with the at least one update in step 1112 or in a different message). For example, the training node 502 may transmit the parameter indicator and the transmission mode indicator in an IM message, such as the IM message described above in respect of FIG. 10.

As only some of the updates may be transmitted in step 1112, only a portion of the one or more scheduling-free resources may be needed for transmission of the at least one of the updates. The training node 502 may calculate an overall packet size including the at least one of the updated and optionally the parameter indicator. The calculation may be performed prior to the transmission in step 1112. The training node 502 may select the required resources from the one or more scheduling-free resources configured in step 1302 for the transmission of the at least one of the updates and optionally the parameter indicator. The training node 502 may, in step 1112, transmit the at least one of the updates and optionally the parameter indicator using the selected resources. The training node 502 may additionally indicate, to the coordinator node 504, the selected resources that are being used for the transmission. This additional indication may be encoded independently and/or transmitted separately from the updates and/or the parameter indicator. This may be analogous to sidelink control information (SCI) and/or coded block groups. Encoding and transmitting the additional indication separately may allow the coordinator node 504 to detect and decode the additional indication first so the receiver can identify the resources being used for the transmission in step 1112.

The method 1100 may be repeated one or more times. The method 1100 may be repeated each time the training node 502 obtains updates to values of the parameters of the machine-learning model, for example. That is, the method 1100 may be repeated for each training round or iteration performed at the training node 502. In some examples, step 1102 might not be repeated in each iteration of the method 1100. For example, step 1102 may involve configuring the training node with one or more scheduling-free resources that reoccur periodically. Some or all of steps 1104-1112 may be performed in advance of each recurrence of the one or more scheduling-free resources.

In the foregoing description of the method 1100, the training node 502 may be configured with one or more scheduling-free resources. This may be referred to as grant-free transmission. In other embodiments, the method 1100 may be adapted for grant-based transmission. That is, the method 1100 may be adapted for situations in which the training node 502 may request a grant for one or more network resources and may receive the grant (e.g. from the coordinator node 504) scheduling the one or more resources. A brief example of how the method 1100 may be adapted for grant-based transmission is described as follows. In this example, the coordinator node 504 may configure, in step 1002, the training node 502 with a metric for training evaluation on the machine-learning model. This may be performed as described above. In step 1010, the training node 502 may transmit a request for a grant for one or more resources. The request may include the transmission mode indicator (e.g. as determined in step 1106). The request may include the total size of the information to be transmitter by the training node 502 (e.g. the size of the at least one of the updates to be transmitted and, optionally the size of the parameter indicator). The request may be an SR (e.g. an enhanced SR). The request may be a BSR.

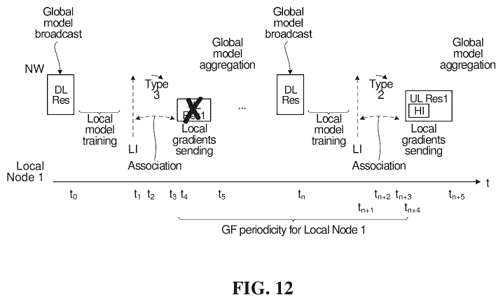

FIG. 12 shows an example implementation of the method 1100 according to embodiments of the disclosure. At time to, the network (NW) may transmit (e.g. broadcast, multi-cast or unicast) the machine-learning model, which is received by a Local Node 1 (“Global model broadcasts”). The Local Node 1 may train the machine-learning model to obtain a first updated machine-learning model with first updates to values of parameters of the machine-learning model. At time t₁, the Local Node 1 may transmit an LI, which is an example of a transmission mode indicator, to the network. The LI may indicate that none of the first updates are to be transmitted to the network (Type 3). Therefore, at time t₄, the Local Node 1 might not transmit the first updates, which is represented by the block UL Res 1 being crossed out. The network may combine updates received from one or more other local nodes (e.g. one or more other training nodes) to obtain a first common updated machine-learning model.

At a later time, tₙ, the network may transmit (e.g. broadcast, multi-cast or unicast) the first common updated machine-learning model, which is received by Local Node 1. tₙ may be the grant-free periodicity of Local Node 1 (e.g. the time period over which the scheduling-free resources for Local Node 1 reoccur). The Local Node 1 may train the model to obtain a second update machine-learning model with second updates to values of parameters of the machine-learning model.

At time tₙ₊₁, the Local Node 1 may transmit an LI, which is an example of a transmission mode indicator, to the network. The LI may indicate that a subset (e.g. only some) of the second updates are to be transmitted to the network (Type 2). At tₙ₊₄, the Local Node 1 may transmit the subset of the second updates to the network. The Local Node 1 may also transmit, with the subset of the second updates, associated HI (e.g. an example of a parameter indicator), to indicate which of the second updates are being transmitted to the network. The network may combine the subset of the second updates with updates received from one or more other local nodes (e.g. other training nodes) to obtain a second common updated machine-learning model.

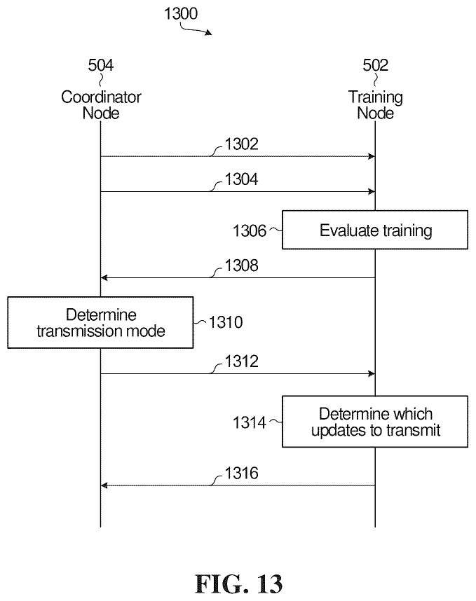

FIG. 13 is a diagram illustrating a method 1300 performed by the coordinator node 504 and the training node 502 according to embodiments of the disclosure. The method 1300 may be an alternative to the method 1100.

The method 1300 may begin with the coordinator node 504 configuring, in step 1302, the training node 502 with one or more scheduling-free network resources. Step 1302 may be performed in accordance with step 1102 described above.

Step 1302 may be performed before, after, or during the training of the machine-learning model by the training node 502 (not illustrated). The training node 502 may train the machine-learning model to obtain an updated machine-learning model with updates to values of parameters of the machine-learning model. The training of the machine-learning model by the training node 502 may be performed as described above in respect of FIG. 5.

In step 1304, the coordinator node 504 may configure the training node 502 with a metric associated with training of the machine-learning model. The coordinator 504 may thus transmit configuration signaling to the training node 502 indicating the metric. The metric may be the metric described above in respect of FIGS. 6-8, for example. The metric may be for evaluation of the training performed by the training node 502.

The coordinator node 504 may configure the training node 502 with the metric using dynamic signaling. That is, the configuration signaling transmitted in step 1304 may be transmitted dynamically. The coordinator node 504 may configure the training node 502 with the metric using semi-static signaling. That is, the configuration signaling transmitted in step 1304 may be transmitted semi-statically. The coordinator node 504 may configure the training node 502 with the metric using Radio Resource Control (RRC) signaling. For example, the configuration signaling transmitted in step 1304 may be transmitted in an RRC message. The coordinator node 504 may configure the training node 502 with the metric using DCI. For example, the configuration signaling transmitted in step 1304 may include a DCI indicating the metric.

Configuring the training node 502 with the metric in step 1304 may comprise transmitting the metric itself to the training node 502. For example, step 1304 may comprise transmitting a rule (e.g. a decision rule) for determining whether or not an update is to be transmitted.

In some examples, step 1304 may comprise transmitting an evaluation parameter for evaluation of the training. For example, step 1304 may involve configuring the training node 502 to use one or more of: a fitness status and the characteristics of the updates as the training evaluation. Step 1304 may also involve configuring the decision making of the transmission mode (e.g. how to the transmission mode may be determined by the training node 502). Step 1304 may also involve configuring how the decision as to what updates to be transmitted is to be made.

In some examples, step 1304 may comprise transmitting a threshold (e.g. a threshold value). The threshold may form part of the metric. The threshold may be for deciding (or determining) whether or not an update is to be transmitted. Step 1304 may comprise transmitting any of the threshold values described above, for example. As another example, step 1304 may comprise transmitting one or more bin values or ranges for binning the updates as part of the metric.

In some examples, the configuration signaling transmitted in step 1304 may be transmitted with the scheduling-free resources transmitted in step 1302 (e.g. they may be transmitted in the same message). Alternatively, they may be transmitted in separate messages.

Alternatively, the training node 502 may obtain the metric through other means. For example, the training node 502 may be pre-configured with the metric. Alternatively, the training node 502 may receive the metric from another node (e.g. another training node).

In step 1306, the training node 502 may evaluate the training of the model using the metric. The training node 502 may, for example, determine the fitting status of the updated model. In another example, the training node 502 may determine a proportion of the updates above a threshold value. In another example, the training node may bin the updates into one or more bins in accordance with a binning scheme defined by the metric.

In step 1308, the training node 502 may report the training evaluation to the coordinator node 504. The training node 502 may report a quantity or verdict based on the metric, for example. In some examples, the training node 502 may, in step 1308, indicate the fitness status (e.g. underfitting, overfitting or good fitting) of the updated model to the coordinator node 504. The training node 502 may indicate the fitness status using an indicator with two or more categorised options. The indicator may have three categorised options such as one option for underfitting, another for overfitting and another for good fitting. For example, the training node 502 may, in step 1308, transmit an indicator reporting message IID2 (‘10’)+‘10’ in which an indicator ID of 2 is associated with a model fitness status and the value of 2 is associated with overfitting.

In another example, the training node 502 may transmit one or more bit sequences mapping to a histogram of the updates in step 1308. The one or more bit sequences may be mapped to the number of updates in each bin of a binning scheme, for example.

The training node 502 may report the training evaluation in a sensing message (e.g. in a message transmitted in a sensing channel). The training evaluation may be indicated by transmitting a sensing signal comprising a waveform that indicates the training evaluation. In another example, step 1308 may comprise transmitting a sensing signal comprising a reference signal (RS) that indicates training evaluation. The resource may be associated with the occasion.

The training node 502 may report the training evaluation in a RACH message (e.g. a message transmitted in a RACH channel). The training node 502 may report the training evaluation with a dedicated preamble (e.g. two or more dedicated preambles). This may allow for short indicator reporting. In some examples, the training node 502 may report the training evaluation in a RACH Message A or a RACH Message 3.

The training node 502 may report the training evaluation in a control channel, such as a PUCCH or an AI control channel. The training node 502 may report the training evaluation in a SR or a BSR. The training node 502 may, for example, use uplink control information (UCI) to indicate the training evaluation. The UCI may be a new UCI (e.g. that uses 2 bits). This may allow for simple training evaluation reporting.

In some examples, the training node 502 may be configured with one or more conditions for reporting the training evaluation to the coordinator node 504. The training node 502 may report the training evaluation in step 1308 responsive to the one or more conditions being satisfied. The one or more conditions may be based on the metric. The one or more conditions may be based on the fitness status and/or a characteristic of the updates. For example, the training node 502 may be configured to report the training evaluation to the coordinator node 504 responsive to the fitness status of the model changing (e.g. from underfitting to good fitting). The training node 502 may receive the one or more conditions from the coordinator mode 504. The training node 502 may receive the one or more conditions with one of the messages received in steps 1302 and 1304, for example. Alternatively, the training node 502 may receive the one or more conditions in a separate (e.g. standalone) message.

In step 1310, the coordinator node 504 may determine the transmission mode based on the reported training evaluation. The transmission mode may be determined using any of the approaches described above. For example, the coordinator node 504 may determine that the training node is to transmit all of the updates based on the fitting status indicated in step 1308 being underfitting. In another example, the coordinator node 504 may determine that the training node is transmit none of the updates based on receiving an indication of a histogram of the updates which indicates that all of the updates are below a threshold value.

In step 1312, the coordinator node 504 may transmit a transmission mode indicator to the training node 502. The transmission mode indicator may be as described above. The transmission mode indicator may be transmitted using any of the approaches described above. For example, the coordinator may indicate the transmission mode to the training node 502 in step 1312 using DCI. In some examples, the coordinator node 504 may transmit the transmission mode indicator to the training node 502 in a message containing a grant for one or more network resources for transmission, by the training node 502, of the updates (not illustrated). The coordinator node 504 may thus transmit the transmission mode indicator in a message switching the training node 502 from grant-free transmission (e.g. using the one or more scheduling-free resources configured in step 1302) to grant-based transmission.

In step 1314, the training node 502 may determine which updates to transmit based on the transmission mode indicator. In an example, the training node 502 may determine that none of the updates are to be transmitted responsive to receiving a transmission mode indicator that indicates none of the updates are to be transmitted (e.g. a Type 3 indicator). The method 1300 may thus stop in step 1314.

In another example, the training node 502 may determine that all of the updates are to be transmitted responsive to receiving a transmission mode indicator that indicates all of the updates are to be transmitted (e.g. a Type 1 indicator).

In another example, the training node 502 may determine that only some of the updates are to be transmitted responsive to receiving a transmission mode indicator that indicates only some of the updates are to be transmitted (e.g. a Type 2 indicator). The training node 502 may further, in step 1314, determine the subset of the updates to be transmitted. The training node 502 may determine the subset of updates to be transmitted using any of the approaches described above. The training node 502 may determine the subset of updates to be transmitted using the metric, for example.

In step 1316, the training node 502 may transmit at least one of the updates to the coordinator node 504. The at least one of the updates may be transmitted using the one or more scheduling-free resources configured in step 1102. Step 1316 may be performed in accordance with step 1112 as described above. Thus, in an example, the training node 502 may transmit the subset of the updates determined in step 1314 and a parameter indicator identifying the subset of the updates that are being transmitted to the coordinator node 504. In another example, the transmission mode indicator in received in step 1312 may indicate that none of the updates are to be transmitted and step 1316 may be omitted.

In the foregoing description of the method 1300, the coordinator node 504 may determine the transmission mode and the training node 502 may determine, based on the transmission mode, which of the updates are to be transmitted. This may provide the advantage of reducing the amount of information that is transmitted to the coordinator node 504, since less information may be needed to determine the transmission mode than to determine which of the updates are to be transmitted. It may also reduce the indication signaling by the coordinator node 504 (e.g. may reduce network-side signaling). In other examples of the method 1300, the coordinator node 504 may determine which of the updates are to be transmitted (e.g. step 1314 may be performed at the coordinator node 504). The coordinator node 504 may determine which of the updates are to be transmitted based on the reported evaluation of the training. The coordinator node 504 may transmit a parameter indicator (e.g. an HI), indicating which of the updates are to be transmitted, to the training node 502. The parameter indicator may be transmitted with the transmission mode indicator in step 1312, or in a separate message.

The method 1300 may be repeated one or more times. The method 1300 may be repeated each time the training node 502 obtains updates to values of the parameters of the machine-learning model, for example. That is, the method 1300 may be repeated for each training node performed at the training node 502. In some examples, step 1302 and/or step 1304 might not be repeated in each iteration of the method 1300. For example, step 1302 may involve configuring the training node 502 with one or more scheduling-free resources that reoccur periodically. Step 1304 may be performed once, and the same metric may be used for future iterations of the method. Some or all of steps 1304-1316 may be performed in advance of each recurrence of the one or more scheduling-free resources.

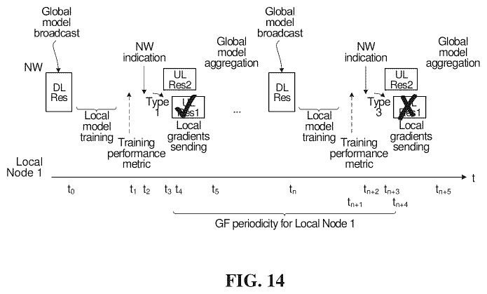

FIG. 14 shows an example implementation of the method 1300 according to embodiments of the disclosure. At time to, the network (NW) may transmit (e.g. broadcast, multi-cast or unicast) the machine-learning model, which is received by a Local Node 1 (“Global model broadcasts”). The Local Node 1 may train the machine-learning model to obtain a first updated machine-learning model with first updates to values of parameters of the machine-learning model. At time t₁, the Local Node 1 may report the metric, which is an example of training evaluation, to the network. At time t₂, the network may indicate a transmission mode indicator to the Local Node indicating that all of the first updates are to be transmitted (Type 1). Therefore, at time t₄, the Local Node 1 may transmit all of the first updates to the network, which is represented by the block UL Res1 being ticked. The network may combine the updates received from Local Node 1 with updates received from one or more other local nodes (e.g. one or more other training nodes) to obtain a first common updated machine-learning model. The updates received from other nodes are represented by the block UL Res2 in FIG. 14.

At a later time, tₙ, the network may transmit (e.g. broadcast, multi-cast or unicast) the first common updated machine-learning model, which is received by Local Node 1. tₙ may be the grant-free periodicity of Local Node 1 (e.g. the time period over which the scheduling-free resources for Local Node 1 reoccur). The Local Node 1 may train the model to obtain a second updated machine-learning model with second updates to values of parameters of the machine-learning model. At time tₙ₊₁, the Local Node 1 may report the metric to the network. The metric may be based on the second updates and may be used to evaluate the training through which the second updates were obtained. At time tₙ₊₂, the network may indicate a transmission mode indicator to the Local Node. The transmission mode indicator may be based on the metric received at time tₙ₊₂. The transmission mode indicator may indicate that none of the second updates are to be transmitted (Type 3). Therefore, at time tₙ₊₄, the Local Node 1 may transmit none of the second updates to the network, which is represented by the block UL Res1 being crossed out. The network may combine updates received from one or more other local nodes (e.g. without the updates from Local Node 1) to obtain a second common updated machine-learning model. The updates received from other nodes are represented by the block UL Res2 in FIG. 14.

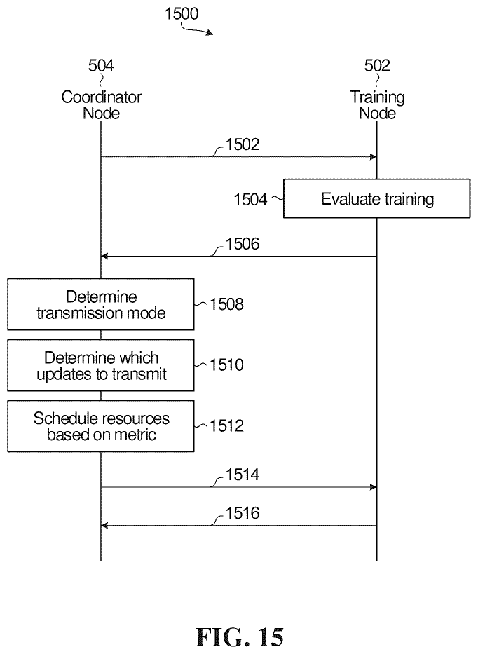

In the methods described above in references to FIGS. 11 and 13, the training node 502 may be configured with one or more scheduling-free network resources. This approach may be referred to as grant-free transmission. In general, aspects of the present disclosure may be implemented in systems using grant-free or grant-based transmission. Thus, in some examples, aspects of the present disclosure may be implemented in systems in which network resources may be dynamically allocated. An example of this is described with reference to FIG. 15.

FIG. 15 is a diagram illustrating a method 1500 performed by the coordinator node 504 and the training node 502 according to embodiments of the disclosure. The method 1500 may be an alternative to the methods 1100 and 1300 described above.

The method 1500 may begin in step 1502, in which the coordinator node 504 may configure the training node 502 with a metric associated with training of the machine-learning model. The metric may be the metric described above in respect of FIGS. 6-8, for example. The metric may be for evaluation of the training performed by the training node 502.

Step 1502 may be performed in accordance with step 1304 described above, for example. Step 1502 may additionally include receiving, at the training node 502 from the coordinator node 504, one or more conditions for reporting the training evaluation to the coordinator node 504. The one or more conditions may be as described above in respect of the method 1300, for example. The one or more conditions may be included in the same message used by the coordinator node 504 to configure the training node 502 with the metric, or a different message.

Step 1502 may be performed before, after, or during the training of the machine-learning model by the training node 502 (not illustrated). The training node 502 trains the machine-learning model to obtain an updated machine-learning model with updates to values of parameters of the machine-learning model. The training of the machine-learning model by the training node 502 may be performed as described above in respect of FIG. 5.

In step 1504, the training node 502 may evaluate the training of the model using the metric. In step 1506, the training node 502 may report the training evaluation to the coordinator node 504. The training node 502 may, in step 1506 transmit a scheduling request to the coordinator node 504 (e.g. in the same message as the report of the training evaluation or in a different message). The training node 502 may, in step 1506, send a suggestion for a transmission mode (e.g. in the same message as the report of the training evaluation and/or the scheduling request, or in a different message). The training node 502 may report the training evaluation to the coordinator node 504 responsive to the one or more conditions being satisfied. Step 1504 may be performed in accordance with step 1306 described above. Step 1506 may be performed in accordance with step 1308 described above.

In step 1508, the coordinator node 504 may determine the transmission mode based on the reported training evaluation. Step 1506 may be performed in accordance with step 1310 described above. In some examples, the coordinator node 504 may determine the transmission mode based on a suggested transmission mode received from the training node 502.

In step 1510, the coordinator node 504 may determine which of the updates are to be transmitted by the training node 502. That is, the coordinator node 504 may determine the subset of updates that are to be transmitted by the training node 502. The coordinator node 504 may determine the subset of updates to be transmitted using any of the approaches described above. The coordinator node 504 determine the subset of the updates based on the training evaluation that was reported in step 1504.

In some examples, step 1510 may be omitted. For example, the coordinator node 504 may determine, in step 1508, that the transmission mode is for the training node 502 to transmit none of the updates, which means the determination in step 1510 may be omitted. In some examples, the method 1500 may end in step 1508 responsive to determining that none of the updates are to be transmitted.

In another example, the coordinator node 504 may determine in step 1508 that the transmission mode is for the training node 502 to transmit all of the updates, which means the determination in step 1510 may be omitted.

In step 1512, the coordinator node 504 may schedule one or more network resources for the training node 502 to use to transmit at least one of the updates to the coordinator node 504. The one or more network resources may comprise time-frequency resources, for example. The coordinator node 504 may schedule one or more network resources for the training node 502 to use to transmit all of the updates to the coordinator node 504 (e.g. when the transmission mode indicates that all of the updates are to be transmitted). Alternatively, the coordinator node 504 may schedule one or more network resources for the training node 502 to use to transmit only some of the updates to the coordinator node 504 (e.g. when the transmission mode indicates that a subset of the updates is to be transmitted). Any suitable methods for scheduling network resources may be used.

In step 1514, the coordinator node 504 may transmit, to the training node 502, a grant scheduling the one or more network resources to be used for transmission of the at least one of the updates from the training node 502 to the coordinator node 504. The coordinator node 504 may thus inform the training node 502 of the network resources that are to be used for transmission of updates to the coordinator node 504. The grant may identify the one or more network resources to the training node 502.

The coordinator node 504 may transmit a parameter indicator (e.g. an HI), indicating which of the updates are to be transmitted, to the training node 502. The parameter indicator may be transmitted with the grant in step 1514, or in a separate message. For example, the parameter indicator may be included as a header with the grant. The parameter indicator may be transmitted using any of the approaches described above. For example, the coordinator node 504 may use DCI signaling as a parameter indicator to indicate which layers of a machine-learning model and optionally which parameters per layer.

The coordinator node 504 may transmit a transmission mode indicator to the training node 502. The coordinator node 504 may include the transmission mode indicator in the same message as the grant transmitted in step 1514. For example, the transmission mode indicator may be included as a header with the grant. The coordinator node 504 may include the transmission mode indicator in the same message as the parameter indicator. Thus, for example, the grant, transmission mode indicator and parameter indicator may be transmitted together (e.g. in the same message) in step 1514. Alternatively, the transmission mode indicator and parameter indicator may be transmitted together (e.g. in the same message) and the grant may be transmitted in a separate message.

In some examples, only the transmission mode indicator may be included in the scheduling grant message, e.g. in DCI or SCI (sidelink control info). For example, the coordinator node 504 may transmit a transmission mode indicator with a scheduling grant (e.g. for certain amount of transmission resources) indicating that one or more of the updates are to be transmitted. The coordinator node 504 may transmit the transmission mode indicator in the scheduling grant message responsive to determining that a subset of the updates is to be transmitted (e.g. based on the fitting status being overfitting).

In some examples, the method may proceed directly from step 1508 to transmitting the transmission mode indicator. For example, the coordinator node 504 may transmit a transmission mode indicator indicating that none of the updates are to be transmitted responsive to determining that none of the updates are to be transmitted (e.g. based on the fitting status being underfitting). In an example, the coordinator node 504 may, in step 1514, transmit a scheduling grant message that includes the transmission mode indicator but does not schedule any network resources.

In step 1516, the training node 502 may transmit the at least one of the updates to the coordinator node 504 using the one or more network resources scheduled in the grant. The training node 502 may perform the transmission in accordance with the transmission mode indicator and/or parameter indicator that may have been received from the coordinator node 504. As the coordinator node 504 decided the subset of updates being transmitted, the parameter indicator may be omitted from the message transmitted in step 1516.

In some embodiments, the coordinator node 504 may transmit only the transmission mode indicator with the grant scheduling the one or more network resources. That is, the coordinator node 504 may transmit the transmission mode indicator with the grant, but without the parameter indicator. This may reduce the signaling of the parameter indicator. The training node 502 may perform the transmission in accordance with the transmission mode indicator. If a subset of the updates is to be transmitted, and the training node 502 may include a parameter indicator in either the same or a different transmission in order to identify the updates corresponding to which parameters of the machine-learning model.

In the foregoing description of the method 1500, the coordinator node 504 may determine the transmission mode which of the updates are to be transmitted. In other examples of the method 1500, the training node 502 may determine which of the updates are to be transmitted. The coordinator node 504 may transmit a transmission mode indicator to the training node 502, indicating the transmission mode determined in step 1508. This may be performed in accordance with step 1312 described above. The training node 502 may determine the subset of the updates to be transmitted. This may be performed in accordance with step 1314 described above. The training node 502 may, in addition to transmitting the at least one update in step 1516, transmit the parameter indicator to the coordinator node 504. This may be performed in accordance with step 1316 described above.

The method 1500 may be repeated one or more times. The method 1300 may be repeated each time the training node 502 obtains updates to values of the parameters of the machine-learning model, for example. That is, the method 1300 may be repeated for each training node performed at the training node 502. In some examples, step 1502 might not be repeated in each iteration of the method 1500. For example, step 1502 may be performed once, and the same metric may be used for future iterations of the method.

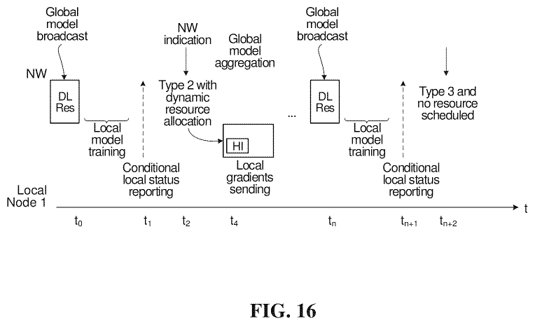

FIG. 16 shows an example implementation of the method 1500 according to embodiments of the disclosure. At time to, the network (NW) may transmit (e.g. broadcast, multi-cast or unicast) the machine-learning model, which is received by a Local Node 1 (“Global model broadcasts”). The Local Node 1 may train the machine-learning model to obtain a first updated machine-learning model with first updates to values of parameters of the machine-learning model. At time t₁, the Local Node 1 may transmit local status reporting, which is an example of training evaluation, to the network. The local status reporting may be transmitted responsive to one or more conditions being met (e.g. as described above in the method 1500). At time t₂, the network may transmit, to the Local Node 1, a grant scheduling one or more network resources along with a transmission mode indicator indicating that a subset of the first updates are to be transmitted (Type 2). Therefore, at time t₂, the Local Node 1 may determine the subset of the first updates to be transmitted (e.g. based on the local status reporting) and may transmit the subset of the first updates to the network, which is represented by the block shown. The Local Node 1 may also transmit a HI, which is an example of a parameter indicator, to the network, indicating which of the parameters are being updated in the subset of the first updates. The network may combine the subset of the first updates received from Local Node 1 with updates received from one or more other local nodes (e.g. one or more other training nodes) to obtain a first common updated machine-learning model.

At a later time, tₙ, the network may transmit (e.g. broadcast, multi-cast or unicast) the first common updated machine-learning model, which is received by Local Node 1. The Local Node 1 may train the model to obtain a second update machine-learning model with second updates to values of parameters of the machine-learning model. At time tₙ₊₁, the Local Node 1 may transmit local status reporting, which is an example of training evaluation, to the network. The local status reporting may be based on the second updates. The local status reporting may be transmitted responsive to one or more conditions being met (e.g. as described above in the method 1500). At time tₙ₊₂, the network may indicate a transmission mode indicator to the Local Node. The transmission mode indicator may be based on the local status reporting received at time tₙ₊₁. The transmission mode indicator may indicate that none of the second updates are to be transmitted (Type 3). Therefore, at time tₙ₊₄, the Local Node 1 may transmit none of the second updates to the network, which is represented by absence of a block in FIG. 16. The network may combine updates received from one or more other local nodes (e.g. without the updates from Local Node 1) to obtain a second common updated machine-learning model.

Embodiments of the disclosure thus provide methods in which it may be determined whether or not an update to a value of a parameter of a machine-learning model is to be transmitted based on an evaluation of the training of the machine-learning model. As described above, the evaluation may be performed at the training node, the coordinator node or distributed across the training node and the coordinator node. The determination of whether or not an update to a value of a parameter is to be transmitted may be made at the training node, the coordinator node or distributed across the training node and the coordinator node. As such, it will be appreciated that the signaling described above in respect of FIGS. 11-16 are provided by way of example only and various modifications or variations may be made. One or more of the steps of the methods described above may be implemented in another of the methods described above. One or more of the steps of the methods described above may be omitted, fore example.

By basing the transmission of updates to a machine-learning model on an evaluation of the training of the machine-learning model, more important updates may be transmitted, whilst less important or detrimental updates might not be transmitted. This allows for effectively training the machine-learning model in a distributed manner whilst reducing signaling overhead.

### Additional Methods

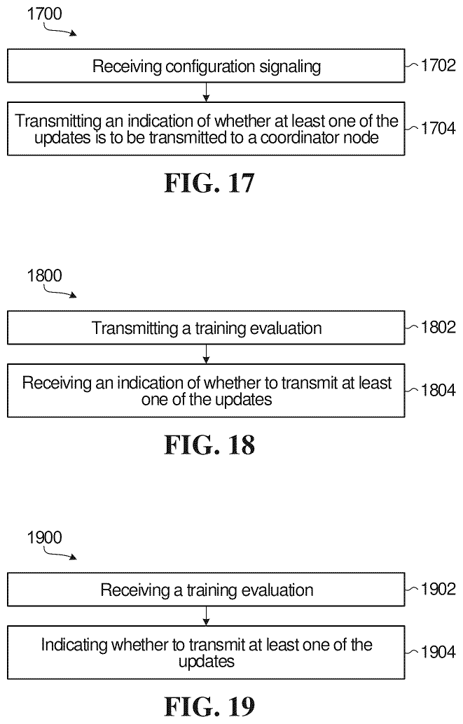

FIG. 17 shows a flowchart of a method 1700 performed by a training node according to embodiments of the disclosure. The training node may be any of the training nodes 502 described above in respect of FIG. 5, for example. The training node may be configured to train a machine-learning model to obtain an updated machine-learning model with updates to values of parameters of the machine-learning model. The training data may train the machine-learning model using training data at the training node. The training data may be specific to (e.g. local to or unique to) the training node. The training node may be one of a plurality of training nodes configured to train respective (e.g. local) versions of the machine-learning model using respective (e.g. local) training data to obtain respective (e.g. local) updated machine-learning models. The respective updated machine-learning models may be for a coordinator node to combine (e.g. aggregate) to determine a common (or global) updated machine-learning model.

The method 1700 may begin, in step 1702, with receiving configuration signaling indicating a metric associated with the training of the machine-learning model. The training node may receive the configuration signaling from the coordinator node, such as the coordinator node 504. The training node may use the metric for evaluation of the training associated with the updates. The training node may, for example, for each iteration of training of the machine-learning model performed by the training node, evaluate the respective training iteration using the metric. For example, the training node may determine a fitting status of the updated model for each training iteration.

The metric may be the metric described above in respect of FIGS. 5-9. The metric may be based on a fitting status of the updated model. The fitting status may comprise one of: underfitting of the updated model, overfitting of the updated model or neither underfitting nor overfitting of the updated model (e.g. good fitting, as described above). The metric may be based on a characteristic of the updates to the values of the parameters. The characteristic of the updates may comprise one or more of: an absolute size of the updates, a size of a respective update to the respective value of the parameter relative to the respective value of the parameter, and for each of the updates to the values of the parameter, a size of the respective update to the respective value of the parameter relative to an earlier update to an earlier value of the parameter.

The configuration signaling may be transmitted to the training node dynamically. The configuration signaling may be transmitted to the training node semi-static signaling. The configuration signaling may be received in RRC signaling (e.g. in an RRC message). The configuration signaling may include a DCI indicating the metric.

Receiving the configuration signaling may involve receiving an indication at least one of an evaluation parameter for evaluation of the training, a rule for deciding whether or not an update is to be transmitted, and a threshold determining which of the updates are to be transmitted.

Step 1702 may be performed in accordance with step 1304 and/or step 1504 described above, for example. Step 1702 may be performed in accordance with the description of receiving the metric by the training node 502 in the method 1100, for example.

In step 1704, the training node may transmit an indication of whether at least one of the updates is to be transmitted to a coordinator node. The indication may be based on the evaluation of the training associated with the updates. The indication may be based on the evaluation of the training with the metric, for example.

The indication may be transmitted via one or more of the following schemes: in a SR (e.g. a modified SR), in a BSR (e.g. in a modified BSR), piggybacked in an uplink transmission (e.g. transmitted in an uplink control or data transmission that would have otherwise been transmitted), in a RACH message, using one or more semi-statically configured network resources, and using one or more preconfigured network resources (e.g. using one or more scheduling-free network resources). For example, the indication may be piggybacked (e.g. transmitted with) a grant-free transmission. In another example, the indication may comprise a dedicated preamble (e.g. that indicates a particular transmission mode). In another example, the indication may be transmitted in a RACH Message A. In another example, the indication may be transmitted in a RACH Message 3. In another example, the indication may be transmitted using one or more scheduling-free network resources (e.g. grant-free network resources), in which there is a time relationship with the scheduling-free networking resources. Networking resources may refer to time-frequency resources, for example.

Transmitting the indication in step 1704 may involve signaling a transmission mode. The transmission mode indicator may indicate whether at least one (e.g. some or all) or none of the updates are to be transmitted by the training node. The transmission mode indicator may be as described above. The transmission mode indicator may be signaled a described above. The transmission mode indicator may comprise the LI described above, for example. Step 1704 may be performed in accordance with step 1110, for example.

The method 1700 may further involve transmitting at least one of the updates (e.g. to the coordinator node). The training node may transmit the at least one of the updates to the coordinator node for combination (e.g. aggregation) with one or more updates from other training nodes. For example, the at least one of the updates may be transmitted for combination with one or more updates from other training nodes for development, by the coordinator node, of a global or common machine-learning model. The operations of the training node may thus form part of a distributed or federated learning process. The transmission of at least one of the updates may be performed in accordance with any of steps 1112, 1316 or 1516 described above. The training node may transmit at least one of the updates with the indication. Alternatively, the indication and the at least one of the updates may be transmitted separately.

In some examples, the method 1700 may further comprise receiving a grant scheduling one or more resources to be used for transmission, to the coordinator node of the at least one of the updates. This may be performed in accordance with step 1514, for example. The grant may be received from the coordinator node. The method 1700 may further involve transmitting the at least one of the updates using the one or more resources.

In some examples, the method 1700 may involve being configured with one or more scheduling-free network resources. This may be performed in accordance with step 1102 or step 1302, for example. The method 1700 involve transmitting the at least one of the updates using at least some of the one or more scheduling-free resources. The training node may thus be able to transmit the at least one of the updates without requesting a scheduling grant.

The method 1700 may further involve transmitting a parameter indicator to the coordinator node. The parameter indicator may identify the parameters for which updates are to be transmitted. For example, the parameter indicator may identify a subset of the updates that are to be transmitted to the coordinator node. The parameter indicator may be as described above. For example, the parameter indicator may comprise the HI described above. The parameter indicate may indicate one or more of: one or more layers of the machine-learning model, one or more parameters for a layer of the machine-learning model, a number of the subset of the updates that are to be transmitted, and an identifier of the machine-learning model. One or more of the parameter indicator, the transmission mode indicator and the at least one the updates may be transmitted in a same message.

In some examples, step 1704 may comprise transmitting at least one of the updates without an explicit indication of what is being transmitted (e.g. without a parameter indicator and/or without a transmission mode indicator). For example, step 1704 may involve transmitting all of the updates. In another example, the transmission mode may be unchanged and thus may be omitted.

In a further aspect, a training node (e.g. an entity or apparatus) configured to perform the method 1700 is also provided. The training node may be any of the training nodes 502. The training node may be a network device (e.g. one of the TRPs 170) or an electronic device (e.g. one or the electronic devices 110), for example. The training node may include a processor and a memory (e.g. a non-transitory processor-readable medium). The memory stores instructions (e.g. processor-readable instructions) which, when executed by a processor of a training node, cause the training node to perform the method 1700. In another aspect, the memory may be provided (e.g. separate to the training node).

Although the method 1700 is described above as being performed by the training node, the method 1700 may, in general, be performed by any suitable node. In some examples, the method 1700 may be distributed across one or more nodes.

FIG. 18 shows a flowchart of a method 1800 performed by a training node according to embodiments of the disclosure. The training node may be any of the training nodes 502 described above in respect of FIG. 5, for example. The training node may be configured to train a machine-learning model to obtain an updated machine-learning model with updates to values of parameters of the machine-learning model. The training node may train the machine-learning model using training data at the training node. The training data may be specific to (e.g. local to or unique to) the training node. The training node may be one of a plurality of training nodes configured to train respective (e.g. local) versions of the machine-learning model using respective (e.g. local) training data to obtain respective (e.g. local) updated machine-learning models. The respective updated machine-learning models may be for a coordinator node to combine (e.g. aggregate) to determine a common (or global) updated machine-learning model.

The method 1800 may begin, in step 1802, with transmitting an indication of evaluation of the training of the machine-learning model. The indication may be transmitted to the coordinator node, such as the coordinator node 504. The training node may use a metric to evaluate the training associated with the updates.

The metric may be the metric described above in respect of FIGS. 5-9. The metric and/or the evaluation of the training may be based on a fitting status of the updated model. The fitting status may comprise one of: underfitting of the updated model, overfitting of the updated model or neither underfitting nor overfitting of the updated model (e.g. good fitting, as described above). The metric and/or the evaluation of the training may be based on a characteristic of the updates to the values of the parameters. The characteristic of the updates may comprise one or more of: an absolute size of the updates, a size of a respective update to the respective value of the parameter relative to the respective value of the parameter, and for each of the updates to the values of the parameter, a size of the respective update to the respective value of the parameter relative to an earlier update to an earlier value of the parameter.

The training node may obtain the metric using any of the means described above in respect of the methods 1100, 1300 and 1500. For example, the training node may be configured with the metric (e.g. as described in step 1304 or 1502. The training node may, for example, for each iteration of training of the machine-learning model performed by the training node, evaluate the respective training iteration using the metric. For example, the training node may determine a fitting status of the updated model for each training iteration.

Step 1802 may be performed in accordance with any of steps 1308 and 1506 described above, for example.

In step 1804, the method 1800 involves receiving an indication of whether to transmit at least one of the updates to the coordinator node. The indication may comprise a transmission mode indicator. The transmission mode indicator may indicate whether or not the training node is to transmit none or at least some (e.g. some or all) of the updates to the coordinator node. The transmission mode indicator may be received in accordance with step 1312 or step 1514 described above, for example.

In some examples, receiving an indication of whether to transmit at least one of the updates may comprise receiving a parameter indicator. The parameter indicator may indicate the parameters for which updates are to be transmitted. For example, the parameter indicator may indicate a subset of the updates for transmission. The parameter indicator may be as described above (e.g. in respect of any of the methods 1100, 1300 and 1500). In some examples, transmission of an explicit transmission mode indicator may be omitted and the parameter indicator may implicitly indicate the transmission mode.

In some examples, the method 1800 may further comprise transmitting at least one of the updates to the coordinator node 504. The training node may transmit the at least one of the updates to the coordinator node for combination (e.g. aggregation) with one or more updates from other training nodes. For example, the at least one of the updates may be transmitted for combination with one or more updates from other training nodes for development, by the coordinator node, of a global or common machine-learning model. The operations of the training node may thus form part of a distributed or federated learning process.

The at least one of the updates may be transmitted in accordance of any of steps 1112, 1316 and 1516 described above. The method 1800 may further comprise receiving a grant scheduling one or more resources (e.g. one or more network resources) for transmission and transmitting the at least one of the updates using the one or more scheduled resources (e.g. as described in the method 1500). In some examples, the training node may be configured with one or more scheduling-free resources and the training node may transmit the at least one update using the one or more scheduling-free resources (e.g. as described in the methods 1100 and 1300). The training node may thus be able to transmit the at least one of the updates without requesting a scheduling grant.

In other examples, the method 1800 might not comprise transmitting at least one update to the coordinator node 504. For example, the indication received in step 1804 may indicate that none of the updates are to be transmitted and thus the training node might not transmit any of the updates.

In a further aspect, a training node (e.g. an entity or apparatus) configured to perform the method 1800 is also provided. The training node may be a network device (e.g. one of the TRPs 170) or an electronic device (e.g. one or the electronic devices 110), for example. The training node may include a processor and a memory (e.g. a non-transitory processor-readable medium). The memory stores instructions (e.g. processor-readable instructions) which, when executed by a processor of a training node, cause the training node to perform the method 1800. In another aspect, the memory may be provided (e.g. separate to the training node).

FIG. 19 shows a flowchart of a method 1900 performed by a coordinator node according to embodiments of the disclosure. The coordinator node may be the coordinator node 504, for example. The coordinator node may be for coordinating training of a machine-learning model by one or more (e.g. a plurality) of training nodes, such as the training nodes 502. Each the training node may be configured to train a respective machine-learning model to obtain an updated machine-learning model with updates to values of parameters of the machine-learning model. The foregoing description will refer to a single training node, but it will be appreciated that, in general, the operations of the coordinator node may be performed in respect of one or more training nodes.

The method 1900 may begin, in step 1902, with receiving an indication of evaluation of training of a machine-learning model from a training node. The training node may have trained the machine-learning model to obtain an updated machine-learning model with updates to values of parameters of the machine-learning model.

A metric may have been used (e.g. by the training node) for evaluation of the training associated with the updates. The metric may be the metric described above in respect of FIGS. 5-9. The evaluation of the training and/or metric may be based on a fitting status of the updated model. The fitting status may comprise one of: underfitting of the updated model, overfitting of the updated model or neither underfitting nor overfitting of the updated model (e.g. good fitting, as described above). The evaluation of the training and/or metric may be based on a characteristic of the updates to the values of the parameters. The characteristic of the updates may comprise one or more of: an absolute size of the updates, a size of a respective update to the respective value of the parameter relative to the respective value of the parameter (e.g. a relative size within a training iteration), and for each of the updates to the values of the parameter, a size of the respective update to the respective value of the parameter relative to an earlier update to an earlier value of the parameter (e.g. a relative size compared to previous updates).

Step 1902 may be performed in accordance with any of steps 1308 and 1506 described above, for example.

The method 1900 may further comprise, in step 1904, indicating, to the training node, whether to transmit at least one of the updates to the coordinator node. The coordinator node may determine whether or not the training node is to transmit at least one of the updated based on the evaluation indicated in step 1902. Making the determination may involve determining a transmission mode (e.g. as in steps 1310 and 1510). Making the determination may also involve determining which of the updates are to be transmitted (e.g. as in step 1510). The coordinator node may, for example, determine a subset of the updates to be transmitted based on the evaluation.

Step 1904 may involve the coordinator node signaling an indicator of the determined transmission mode (e.g. a transmission mode indicator) to the training node. This may be performed in accordance with step 1312 or step 1514, for example. The coordinator node may, for example, indicate to the training node whether at least one (e.g. some or all) or none of the updates are to be transmitted.

Step 1904 may additionally involve the coordinator node transmitting a parameter indicator to the training node. The parameter indicator may the updates to be transmitted. It may be particularly appropriate to transmit the parameter indicator when only a subset of the updates is to be transmitted since the prevents the training node from having to determine which updates are to be transmitted. The parameter indicator may thus indicate the subset of updates to be transmitted.

In some examples, the coordinator node may transmit the transmission mode indicator and the parameter indicator to the training node in the same message. In other examples, the coordinator node may transmit the transmission mode indicator and the parameter indicator to the training node in different messages. In yet other examples, the coordinator node may transmit the transmission mode indicator to the training node and the training node may determine which of the updates are to be transmitted (e.g. as described in respect of step 1314 above).

The method 1900 may further involve receiving at least one of the updates from the training node. The at least one of the updates may be transmitted in accordance with the indicator sent by the coordinator node in step 1904.

In some examples, the method 1900 may involve receiving updates from a plurality of training nodes. Each of the plurality of training nodes may train the machine-learning model using training data at the training node. The training data may be specific to (e.g. local to or unique to) the training node. Each of the plurality of training nodes may train respective (e.g. local) versions of the machine-learning model using respective (e.g. local) training data to obtain respective (e.g. local) updated machine-learning models comprising respective updates to values of parameters of the machine-learning model.

Thus, the method 1900 may be performed in respect of a plurality of training nodes (some or all of which may operate in accordance with the training nodes described herein). The coordinator node may combine (e.g. aggregate) the updates received from the plurality of training nodes to develop, by the coordinator node, a common (or global) updated machine-learning model.

In a further aspect, a coordinator node (e.g. an entity or apparatus) configured to perform the method 1900 is also provided. The coordinator node may be a core network node (e.g. a node in the core network 130), a network device (e.g. one of the TRPs 170) or an electronic device (e.g. one or the electronic devices 110), for example. The coordinator node may include a processor and a memory (e.g. a non-transitory processor-readable medium). The memory stores instructions (e.g. processor-readable instructions) which, when executed by a processor of a coordinator node, cause the coordinator node to perform the method 1900. In another aspect, the memory may be provided (e.g. separate to the coordinator node).

### Closing Paragraphs

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the figures or all of the portions schematically shown in the figures. Moreover, selected features of one example embodiment may be combined with selected features of other example embodiments.

While this disclosure has been described with reference to illustrative embodiments, this description is not intended to be construed in a limiting sense. Numerous modifications and variations of the present disclosure are possible in light of the above teachings. It is therefore to be understood that within the scope of the appended claims, the disclosure may be practiced otherwise than as specifically described herein.

1. A method performed by a training node, the method comprising:
receiving configuration signaling indicating a metric associated with training of a machine-learning model, wherein the training of the machine-learning model is performed to obtain an updated machine-learning model with updates to values of parameters of the machine-learning model, and wherein the metric is used for evaluation of the training associated with the updates; and
transmitting an indication of whether at least one of the updates is to be transmitted to a coordinator node, wherein the indication is based on the evaluation of the training associated with the updates.

2. The method of claim 1, wherein the receiving the configuration signaling indicating the metric comprises receiving an indication of at least one of:
an evaluation parameter for the evaluation of the training;
a rule for deciding whether or not an update is to be transmitted; or
a threshold for determining which of the updates are to be transmitted.

3. The method of claim 1, wherein the indication signals a transmission mode, and wherein:
the transmission mode indicates at least one of the updates is to be transmitted; or
the transmission mode indicates none of the updates are to be transmitted.

4. The method of claim 3, wherein the transmission mode indicates the at least one of the updates is to be transmitted, the method further comprising:
transmitting the at least one of the updates to the coordinator node in accordance with the transmission mode.

5. The method of claim 4, further comprising:
receiving, from the coordinator node, a grant scheduling one or more resources,
wherein the transmitting the at least one of the updates to the coordinator node in accordance with the transmission mode comprises transmitting the at least one of the updates using the one or more resources.

6. A method performed by a coordinator node, the method comprising:
receiving, from a training node, an indication of evaluation of training of a machine-learning model to obtain an updated machine-learning model with updates to values of parameters of the machine-learning model, wherein a metric is used for evaluation of the training associated with the updates; and
based on the indication of the evaluation, indicating, to the training node, whether to transmit at least one of the updates to the coordinator node.

7. The method of claim 6, wherein the indicating, to the training node, whether to transmit the at least one of the updates to the coordinator node comprises:
signaling a transmission mode to the training node, wherein the transmission mode is based on the metric, wherein the transmission mode indicates whether to transmit none, some, or all of the updates to the coordinator node.

8. The method of claim 6, wherein the indicating, to the training node, whether to transmit the at least one of the updates to the coordinator node comprises:
transmitting a parameter indicator to the training node, wherein the parameter indicator identifies a subset of the updates to be transmitted to the coordinator node.

9. The method of claim 8, further comprising:
transmitting, to the training node, a grant scheduling one or more resources; and
receiving, from the training node, the subset of the updates transmitted on the one or more resources.

10. The method of claim 6, wherein the metric is based on a fitting status of the updated machine-learning model.

11. A training node comprising:
at least one processor; and
a memory storing instructions which, when executed by the at least one processor, cause the training node to perform operations including:
receiving configuration signaling indicating a metric associated with training of a machine-learning model, wherein the training of the machine-learning model is performed to obtain an updated machine-learning model with updates to values of parameters of the machine-learning model, and wherein the metric is used for evaluation of the training associated with the updates; and
transmitting an indication of whether at least one of the updates is to be transmitted to a coordinator node, wherein the indication is based on the evaluation of the training associated with the updates.

12. The training node of claim 11, wherein the receiving the configuration signaling indicating the metric comprises receiving an indication of at least one of:
an evaluation parameter for the evaluation of the training;
a rule for deciding whether or not an update is to be transmitted; or
a threshold for determining which of the updates are to be transmitted.

13. The training node of claim 11, wherein the indication signals a transmission mode, and wherein:
the transmission mode indicates at least one of the updates is to be transmitted; or
the transmission mode indicates none of the updates are to be transmitted.

14. The training node of claim 13, wherein the transmission mode indicates at least one of the updates is to be transmitted, and the operations further comprising:
transmitting the at least one of the updates to the coordinator node in accordance with the transmission mode.

15. The training node of claim 14, the operations further comprising:
receiving, from the coordinator node, a grant scheduling one or more resources,
wherein the transmitting the at least one of the updates to the coordinator node in accordance with the transmission mode comprises transmitting the at least one of the updates using the one or more resources.

16. A coordinator node comprising:
at least one processor; and
a memory storing instructions which, when executed by the at least one processor, cause the coordinator node to perform operations including:
receiving, from a training node, an indication of evaluation of training of a machine-learning model to obtain an updated machine-learning model with updates to values of parameters of the machine-learning model, wherein a metric is used for evaluation of the training associated with the updates; and
based on the indication of the evaluation, indicate, to the training node, whether to transmit at least one of the updates to the coordinator node.

17. The coordinator node of claim 16, wherein the indicating, to the training node, whether to transmit the at least one of the updates to the coordinator node comprises:
signaling a transmission mode to the training node, wherein the transmission mode is based on the metric, wherein the transmission mode indicates whether to transmit none, some or all of the updates to the coordinator node.

18. The coordinator node of claim 16, wherein the indicating, to the training node, whether to transmit the at least one of the updates to the coordinator node comprises:
transmitting a parameter indicator to the training node, wherein the parameter indicator identifies a subset of the updates to be transmitted to the coordinator node.

19. The coordinator node of claim 18, the operations further comprising:
transmit, to the training node, a grant scheduling one or more resources; and
receive, from the training node, the subset of the updates transmitted on the one or more resources.

20. The coordinator node of claim 16, wherein the metric is based on a fitting status of the updated machine-learning model.
